(19) United States
(12) Patent Application Publication
(10) Pub. No.: US 2018/0129466 A1
(43) Pub. Date: May 10, 2018

(54) DISPLAY CONTROL DEVICE AND DISPLAY SYSTEM

(71) Applicant: SHARP KABUSHIKI KAISHA, Osaka (JP)

(72) Inventor: NORIYOSHI KANKI, Sakai City (JP)

(21) Appl. No.: 15/807,903

(22) Filed: Nov. 9, 2017

(30) Foreign Application Priority Data
Nov. 9, 2016 (JP) 2016-218967

(51) Int. Cl. G06F 3/14

(52) U.S. Cl. CPC G06F 3/1446; G06F 3/041

(57) ABSTRACT

A display control device selects a display device operated by a user as an operation target display device, and a display device different from the operation target display device and arranged adjacent to the right of the operation target display device as a selection display device. The display control device displays received image data on the display device which is the selection display device.

### BACKGROUND

### 1. Field

The present disclosure relates to a display control device for displaying image data by using a plurality of display devices.

### 2. Description of the Related Art

A multi-display system in which a plurality of display devices are arranged side by side has been developed. In the multi-display system, the plurality of display devices can be configured as one screen, and content such as image data can be displayed on the one screen of the plurality of display devices.

For example, in a case where two display devices are arranged side by side as the multi-display, a user (for example, teacher or presenter) displays image data on the multi-display and can perform a class or a lecture to a viewer (for example, student or participant).

However, since the two display devices are configured as one screen in the multi-display, in a case of displaying the image data, the image data is displayed across the two display devices.

Japanese Patent No. 4799013 discloses a technique of automatically moving image data to one display device among two display devices in a case where the image data is displayed across the two display devices.

Japanese Patent No. 5777915 discloses a technique of moving image data to one display device among two display devices by a swipe operation (slide operation) of a user in a case where the image data is displayed across the two display devices. A technique of moving image data by a slide operation is disclosed in Japanese Unexamined Patent Application Publication No. 11-191036.

However, in the techniques disclosed in Japanese Patent No. 4799013 and Japanese Patent No. 5777915, the image data is displayed across the two display devices at the start. For the user (for example, teacher or presenter) and the viewer (for example, student or participant), it is preferable to display the image data in an easily viewable manner at the start.

In the technique disclosed in Japanese Patent No. 4799013, in order to display the image data in an easily viewable manner for a user, the image data is moved automatically to one display device among the two display devices. For the user, for convenience of teaching or lecturing to the viewer, it is desirable that the image data is not to be moved automatically (that is, without permission), but is displayed at an intended position.

In the technique disclosed in Japanese Patent No. 5777915, in order for the user to view the image data in an easily viewable manner, the user himself/herself moves the image data to one display device among the two display devices. For the user, for advancing the class or the lecture, it is not convenient to move by himself/herself the image data to one display device of the two display devices.

In the techniques disclosed in Japanese Patent No. 4799013 and Japanese Patent No. 5777915, in a case where the image data is displayed on a display device being operated by the user, for example, it takes time and effort for the user to move the image data to one display device among the two display devices since the image data disturbs the operation of the user.

The present disclosure is made in view of the above problems in the related art, there is provided a display control device and the like capable of displaying content data at a position of not disturbing an operation of a user in a case of displaying the data using a plurality of display devices.

### SUMMARY

In view of the problems described above, a display control device according to the present disclosure includes a device selection unit that selects a display device operated by a user as an operation target display device from among the plurality of display devices; a content data reception unit that receives content data; and a display control unit that displays the received content data on a display device other than the operation target display device.

A display control device according to the present disclosure includes a content data reception unit that receives content data; a notification control unit that notifies a user that the content data is received by displaying notification screen on a plurality of display devices to each of which each specific operation is assigned; a device selection unit that selects a display device on which the specific operation is performed by the user as the operation target display device from among the plurality of display devices; and a display control unit that displays the received content data on a display device other than the operation target display device selected by the specific operation.

A display system according to the present disclosure includes a plurality of display devices and a display control device connected to the plurality of display devices. The display control device includes a device selection unit that selects a display device operated by a user as an operation target display device from among the plurality of display devices; a content data reception unit that receives content data; and a display control unit that displays the received content data on a display device other than the operation target display device.

A display method according to the present disclosure includes selecting a display device operated by a user as an operation target display device from among the plurality of display devices; receiving content data; and displaying the received content data on a display device other than the operation target display device.

A non-transitory computer readable storage medium stores a program according to the present disclosure causing a computer connected to a plurality of display devices to realize a device selection function that selects a display device operated by a user as an operation target display device from among the plurality of display devices; a content data reception function that receives content data; and a display control function that displays the received content data on a display device other than the operation target display device.

### BRIEF DESCRIPTION OF THE DRAWINGS

FIG. 1 is a block diagram illustrating a configuration of a display system according to a first embodiment;

FIG. 2 is a diagram illustrating a table of a display control device of the display system according to the first embodiment;

FIG. 3 is a flowchart illustrating an operation (display processing) of the display system according to the first embodiment;

FIG. 4 is a diagram for illustrating an operation example of the display system according to the first embodiment;

FIG. 5 is a diagram for illustrating an operation example of the display system according to the first embodiment;

FIG. 6 is a diagram for illustrating an operation example of a display system according to a second embodiment;

FIG. 7 is a diagram for illustrating an operation example of the display system according to the second embodiment;

FIG. 8 is a block diagram illustrating a configuration of a display system according to a third embodiment;

FIG. 9 is a diagram for illustrating an operation example of the display system according to the third embodiment;

FIG. 10 is a diagram for illustrating an operation example of the display system according to the third embodiment;

FIG. 11 is a diagram for illustrating an operation example of a display system according to a fourth embodiment;

FIG. 12 is a diagram for illustrating an operation example of the display system according to the fourth embodiment;

FIG. 13 is a diagram for illustrating an operation example of a display system according to a fifth embodiment;

FIG. 14 is a diagram for illustrating an operation example of the display system according to the fifth embodiment;

FIG. 15 is a diagram illustrating a table of a display control device of a display system according to a sixth embodiment;

FIG. 16 is a diagram for illustrating an operation example of the display system according to the sixth embodiment;

FIG. 17 is a diagram for illustrating an operation example of the display system according to the sixth embodiment;

FIG. 18 is a diagram illustrating a table of a display control device of a display system according to a seventh embodiment;

FIG. 19 is a diagram for illustrating an operation example of the display system according to the seventh embodiment;

FIG. 20 is a diagram for illustrating an operation example of the display system according to the seventh embodiment;

FIG. 21 is a block diagram illustrating a configuration of a display system according to an eighth embodiment;

FIG. 22 is a diagram illustrating a table of a display control device of the display system according to the eighth embodiment;

FIG. 23 is a flowchart illustrating an operation (display processing) of the display system according to the eighth embodiment;

FIG. 24 is a diagram for illustrating an operation example of the display system according to the eighth embodiment;

FIG. 25 is a diagram for illustrating an operation example of the display system according to the eighth embodiment;

FIG. 26 is a diagram for illustrating an operation example of the display system according to the eighth embodiment;

FIG. 27 is a diagram for illustrating an operation example of the display system according to the eighth embodiment;

FIG. 28 is a diagram illustrating a table of a display control device of a display system according to a ninth embodiment;

FIG. 29 is a diagram for illustrating an operation example of the display system according to the ninth embodiment;

FIG. 30 is a diagram for illustrating an operation example of the display system according to the ninth embodiment;

FIG. 31 is a diagram for illustrating an operation example of a display system according to a tenth embodiment;

FIG. 32 is a diagram for illustrating an operation example of the display system according to the tenth embodiment;

FIG. 33 is a diagram for illustrating an operation example of the display system according to the tenth embodiment;

FIG. 34 is a diagram for illustrating an operation example of the display system according to the tenth embodiment; and

FIGS. 35A and 35B are diagrams for illustrating modification examples.

### DESCRIPTION OF THE EMBODIMENTS

Hereinafter, embodiments of the present disclosure will be described in detail with reference to drawings. In the description described below, a display system of the present disclosure will be described as an example. The embodiments are examples for describing the present disclosure, and it goes without saying that the present disclosure is not limited to content of the embodiments.

### 1. First Embodiment

First, a first embodiment will be described. In the first embodiment, a display device operated by a user (operator) is selected from among a plurality of display devices as an operation target display device, a display device arranged adjacent to the operation target display device is selected as a selection display device, and the selection display device displays content data.

### [1.1 Overall Configuration]

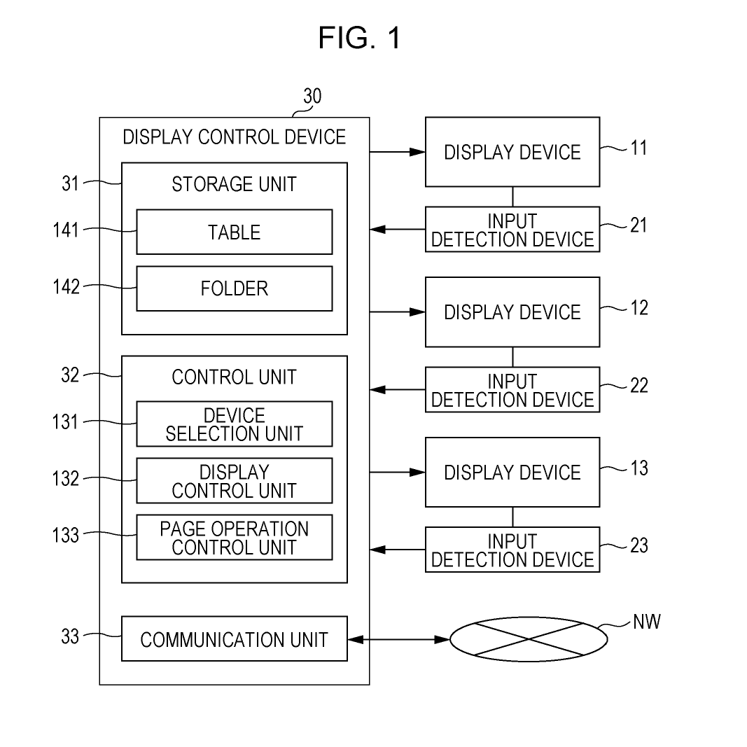

First, the overall configuration will be described with reference to a drawing. FIG. 1 is a block diagram illustrating the configuration of a display system according to the first embodiment. As illustrated in FIG. 1, the display system includes a plurality of display devices, a plurality of input detection devices, and a display control device 30.

The plurality of display devices are liquid crystal displays (LCDs) not shown. In the embodiment, the plurality of display devices are, for example, three display devices 11 to 13. The plurality of display devices 11 to 13 are arranged in a row.

The plurality of input detection devices are touch panels. In the embodiment, the plurality of input detection devices are three input detection devices 21 to 23. The plurality of input detection devices 21 to 23 are disposed respectively in the plurality of display devices 11 to 13. That is, each of the plurality of display devices 11 to 13 is used as a touch panel display with its own LCD and each of the plurality of input detection devices 21 to 23 (touch panels). When a user inputs a character or the like to the plurality of display devices 11 to 13 with the fingertip or a pen tip, each of the plurality of input detection devices 21 to 23 detects the user input to the plurality of display devices 11 to 13 as input information.

As the plurality of input detection devices 21 to 23, a capacitance sensor or an optical sensor is exemplified. The capacitance sensors are, for example, arranged in the LCDs of the plurality of display devices 11 to 13 in a matrix form so as to form a coordinate and detect a specification medium (pen tip or fingertip of a user) close to a predetermined distance or less to the LCDs. The optical sensors are arranged in a matrix form by being built in each pixel of the LCDs of the plurality of display devices 11 to 13 and detect the specification medium (pen tip or fingertip of a user) in contact with the LCDs.

The display control device 30 is connected to the plurality of display devices 11 to 13 and the plurality of input detection devices 21 to 23. For example, in a case where the input detection device 21 among the plurality of input detection devices 21 to 23 detects input information to the display device 11 among the plurality of display devices 11 to 13, the display control device 30 displays the input information on the display device 11. Consequently, when a user (for example, teacher or presenter) explains a viewer (for example, student or participant) using the touch panel display, the input information can be reflected in the display device 11.

### [1.2 Functional Configuration]

A functional configuration of the display control device 30 will be described with reference to drawings.

The display control device 30 includes a storage unit 31, a control unit 32, and a communication unit 33. The control unit 32 is a central processing unit (CPU) and controls the plurality of input detection devices 21 to 23 and the plurality of display devices 11 to 13. The storage unit 31 stores a computer program, and the control unit 32 executes the computer program.

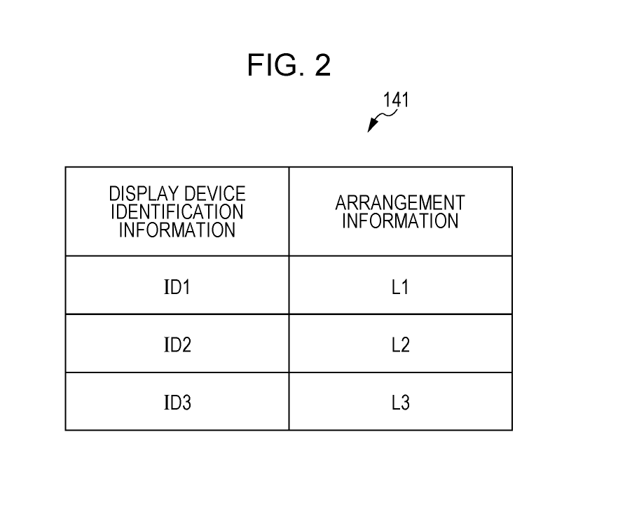

The storage unit 31 includes a table 141. FIG. 2 is a diagram illustrating the table 141 of the display control device 30 of the display system according to the first embodiment. As illustrated in FIG. 2, the table 141 stores a plurality of display device identification information ID1 to ID3 for identifying each of the plurality of display devices 11 to 13. The table 141 also stores arrangement information indicating the arrangement (alignment) of the plurality of display devices 11 to 13. The table 141 also stores, not shown, a result (including arrangement state) of selection of the operation target display device and the selection display device which will be described below.

Specifically, the plurality of display devices 11 to 13 are arranged side by side in the order from the left to the right. In the case, the table 141 stores arrangement information L1 representing the first from the left with respect to the display device identification information ID1 for identifying the display device 11, arrangement information L2 representing the second from the left with respect to the display device identification information ID2 for identifying the display device 12, and arrangement information L3 representing the third from the left with respect to the display device identification information ID3 for identifying the display device 13.

As illustrated in FIG. 1, the storage unit 31 further includes a folder 142. When image data is received from another device, the control unit 32 saves the image data in the folder 142.

As illustrated in FIG. 1, the control unit 32 includes a device selection unit 131, a display control unit 132, and a page operation control unit 133.

The device selection unit 131 selects a display device (for example, display device 11) being operated by a user as the operation target display device from among the plurality of display devices 11 to 13. The operation of the user is performed by the touch (finger or pen), and the operation target display device (display device 11) is determined by a position of the touch (finger or pen) being performed by the user.

In a case of selecting the display device to be the operation target, in some cases, it may be a display device currently being operated or a display device which is operated. Specifically, there are cases where a display device being operated at the time of the selection is selected, or a display device which is operated last is selected. There are cases where a display device close to a user (presenter or teacher) is selected as the display device being operated, or the primary display is selected as the display device being operated. A display of a region including the active window may be the display device being operated.

The device selection unit 131 selects one display device from the display devices 12 and 13 other than the operation target display device (display device 11) as the selection display device.

The selection display device is a selected display device from one or a plurality of display devices as a device for displaying received content data (image data). As the selection display device, a display device displaying the content data (image data) may be selected, or a display device that does not display the content data (image data) may be selected (in the case, a display device other than the selected display device not to display the data becomes the selection display device).

A display device other than the operation target display device may be selected simply as the selection display device. That is, it is satisfactory as long as a display device for displaying the received content data can be specified.

As a condition for selecting the selection display device, the selection display device firstly represents a display device arranged adjacent to the operation target display device and secondly represents a display device disposed in the right side of the operation target display device. For example, in a case where the operation target display device is the display device 11 (display device of arrangement information L1), the selection display device is the display device 12 (display device of arrangement information L2) which is arranged adjacent to the display device 11 and disposed in the right side thereof. For example, in a case where the operation target display device is the display device 12 (display device of arrangement information L2), the selection display device is the display device 13 (display device of arrangement information L3) which is disposed in the right side of display device 12 among the display devices 11 and 13 arranged adjacent to the display device 12. For example, in a case where the operation target display device is the display device 13 (display device of arrangement information L3), the selection display device is the display device 12 (display device of arrangement information L2) which is arranged adjacent to the display device 13.

The display control unit 132 displays the image data saved in the folder 142 on the selection display device.

The page operation control unit 133 performs a page operation (page forward or page back) by the touch of a user on a display device.

The communication unit 33 is a functional unit for communicating with another device (for example, server, portable terminal device, or image forming device). For example, the unit is connected to a network NW using the wired LAN or the wireless LAN and is connectable to another device (not shown) which is connected to the network NW. The unit may be connected directly to another device using the near-field wireless communication such as Bluetooth (registered trademark) or near field radio communication (NFC), or WiFi.

### [1.3 Processing Flow]

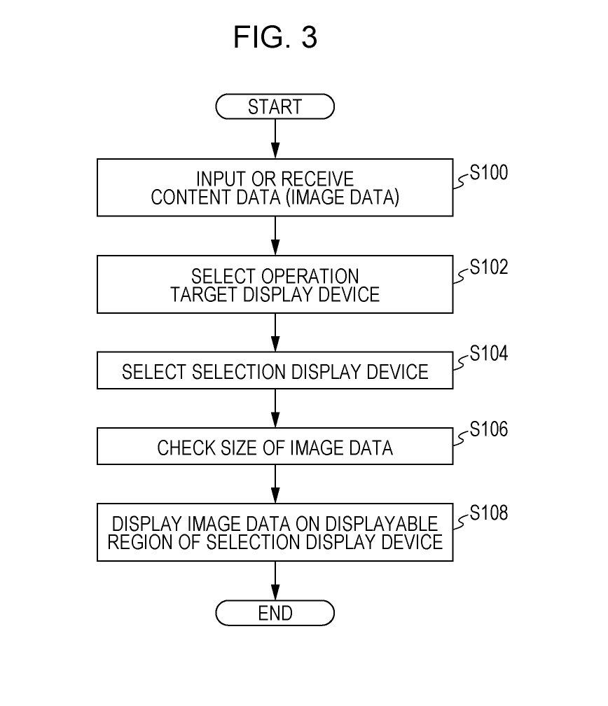

Next, a processing flow according to the embodiment will be described with reference to a drawing. FIG. 3 is a flowchart illustrating an operation (display processing) of the display system according to the first embodiment.

In the display control device 30, the control unit 32 inputs or receives the content data through the communication unit 33 (step S100). At the time, the control unit 32 saves the content data in the folder 142.

Here, there are various data as the content data to be received. In the following description, for convenience of explanation, a case of receiving image data as an example will be described, but another data such as text data (text message), moving image data, or sentence data may be received.

In the present disclosure, a case where the content data is received from another device will be described, but may be received, for example, from an external storage device such as a USB memory. In the case, the communication unit 33 is realized by the USB interface or the like.

The device selection unit 131 selects the operation target display device (for example, display device 11) from among the plurality of display devices 11 to 13 based on the position of the touch by the user (finger or pen) currently performed by the user (step S102).

Here, in order to select the operation target display device, it may be determined firstly whether a display device is in an operation state by the user. There are various methods of determining the device to be in the operation state. In the embodiment, whether the device is in the operation state is determined based on the position of the touch by the user. A display device that is determined to be in the operation state is selected as the operation target display device.

Hereinafter, in the case of selecting the operation target display device, it is determined whether each display device is in the operation state, and processing for selecting the display device determined to be in the operation state as the operation target display device is executed.

The device selection unit 131 selects one display device (for example, display device 12) from among the display device 12, 13 other than the operation target display device (display device 11) (step S104) as the selection display device.

The display control unit 132 checks a size of the image data (step S106). The display control unit 132 displays the image data on a displayable region of the selection display device (display device 12) (step S108).

### [1.4 Operation Example]

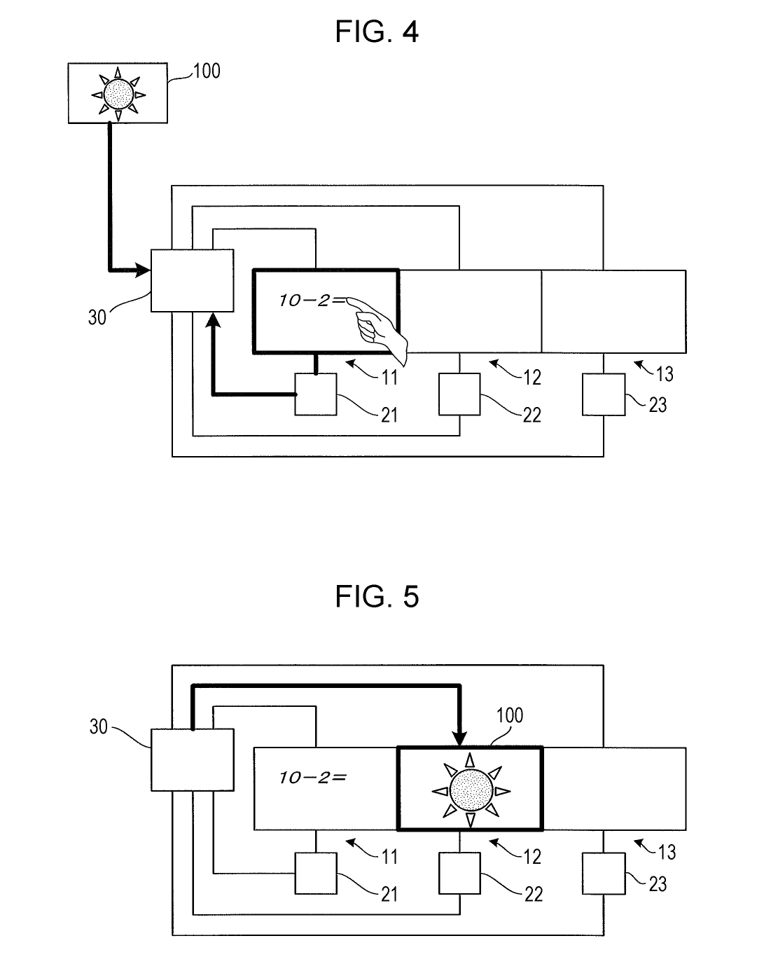

Next, operation examples according to the embodiment will be described with reference to drawings. FIGS. 4 and 5 are diagrams for illustrating operation examples of the display system according to the first embodiment.

As illustrated in FIG. 4, for example, it is assumed that the user performs a touch operation for inputting a character “10−2=” by the fingertip or a pen on the display device 11 among the plurality of display devices 11 to 13. At the time, the input detection device 21 among the plurality of input detection devices 21 to 23 detects the user input to the display device 11 as input information. The input information includes the character “10−2=” and the position (coordinate) specified on the display device 11. The display control unit 132 of the display control device 30 displays the input information at the specification position of the display device 11.

As illustrated in FIG. 4, the control unit 32 of the display control device 30 inputs or receives image data 100 and saves the image data 100 in the folder 142. The device selection unit 131 of the display control device 30 selects the display device 11 disposed in correspondence with the input detection device 21 that detects the input information as the operation target display device from among the plurality of display devices 11 to 13. That is, the display device 11 in which the character “10−2=” of the input information is displayed is selected as operation target display device.

As illustrated in FIG. 5, the device selection unit 131 of the display control device 30 selects the display device (display device 12) arranged adjacent to the right of the operation target display device (display device 11) as the selection display device from among the plurality of display devices 11 to 13. At the time, the display control unit 132 of the display control device 30 displays the image data 100 on a displayable region of the selection display device (display device 12).

In a case where one display device is selected as the selection display device, the display control unit 132 displays the image data so as to be displayed in a display region of the selected display device. In a case where a plurality of selection display devices are selected, two display devices may be displayed as one display region so as to across the image data.

As described above, the display system according to the first embodiment includes the plurality of display devices 11 to 13 arranged side by side and the display control device 30 connected to the plurality of display devices 11 to 13. The display control device 30 includes the device selection unit 131 and the display control unit 132. The device selection unit 131 selects the display device 11 operated by the user as the operation target display device from among the plurality of display devices 11 to 13. The device selection unit 131 selects one display device (in the case, display device 12) which is different from the operation target display device (display device 11) and arranged adjacent to the right of the operation target display device (display device 11) as the selection display device from among the plurality of display devices 11 to 13. The display control unit 132 displays the received image data 100 on the selection display device (display device 12).

With the display system according to the first embodiment, in order to make the image data 100 for the user (for example, teacher or presenter) or the viewer (for example, student or participant) to view in an easily viewable manner, the image data 100 is displayed on the display device 12 which is not operated by the user. Consequently, in the display system according to the first embodiment, in the case of displaying the received content data using the plurality of display devices 11 to 13, it is possible to display the data at a position of not disturbing an operation of the user.

### 2. Second Embodiment

Next, a second embodiment will be described. In the first embodiment, the display device (display device 12) arranged adjacent to the right of the operation target display device (display device 11) is selected as the selection display device, and the image data 100 is displayed on the displayable region of the selection display device (display device 12), but the present disclosure is not limited thereto. For example, in the second embodiment, a display device other than the operation target display device is selected as the selection display device, and the image data 100 is displayed on the displayable region of the selection display device. In a display system according to the second embodiment, changes from the first embodiment will be described.

### [2.1 Operation Example]

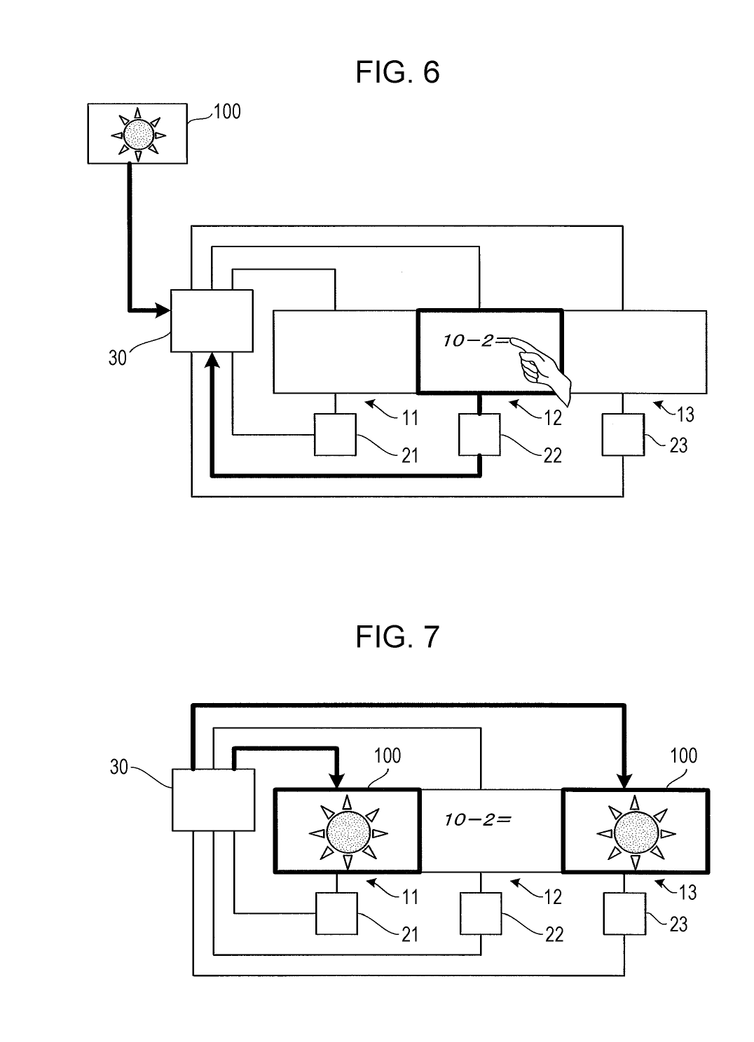

FIGS. 6 and 7 are diagrams for illustrating operation examples of the display system according to the second embodiment.

As illustrated in FIG. 6, for example, it is assumed that a user performs a touch operation for inputting character “10−2=” by the fingertip or a pen on the display device 12 among the plurality of display devices 11 to 13. At the time, the input detection device 22 among the plurality of input detection devices 21 to 23 detects the user input to the display device 12 as input information. The input information includes the character “10−2=” and the position (coordinate) specified on the display device 12. The display control unit 132 of the display control device 30 displays the input information at the specification position of the display device 12.

As illustrated in FIG. 6, the control unit 32 of the display control device 30 inputs or receives image data 100 and saves the image data 100 in the folder 142. The device selection unit 131 of the display control device 30 selects the display device 12 disposed in correspondence with the input detection device 22 that detects the input information as the operation target display device from among the plurality of display devices 11 to 13. That is, the display device 12 in which the character “10−2=” of the input information is displayed is selected as operation target display device.

As illustrated in FIG. 7, the device selection unit 131 of the display control device 30 selects the display devices 11 and 13 other than the operation target display device (display device 12) as the selection display device. That is, the display devices 11, 13 arranged on both sides of the operation target display device (display device 12) are selected as the selection display device. At the time, the display control unit 132 of the display control device 30 displays the image data 100 on a displayable region of the selection display devices (display devices 11 and 13).

As described above, the display system according to the second embodiment includes the plurality of display devices 11 to 13 and the display control device 30 connected to the plurality of display devices 11 to 13. The display control device 30 includes the device selection unit 131 and the display control unit 132. The device selection unit 131 selects the display device 12 operated by the user as the operation target display device from among the plurality of display devices 11 to 13. The device selection unit 131 selects the display devices 11 and 13 other than the operation target display device (display device 12) as the selection display device. That is, the display devices 11, 13 arranged on both sides of the operation target display device (display device 12) are selected as the selection display device. The display control unit 132 displays the received image data 100 on the selection display device (display devices 11 and 13).

With the display system according to the second embodiment, in order to make the image data 100 for the user (for example, teacher or presenter) or the viewer (for example, student or participant) to view in an easily viewable manner, the image data 100 is displayed on the display devices 11 and 13 which is not operated by the user. Consequently, in the display system according to the second embodiment, when the received content data is displayed using the plurality of display devices 11 to 13, since the received data is displayed on the display device other than the display device being operated, and it is possible to display the received content data at a position of not disturbing a display being operated. Further, since the data can be displayed on the plurality of display devices, it is possible to provide the display system to be viewed for the viewer.

### 3. Third Embodiment

Next, a third embodiment will be described. In the third embodiment, a location of a user who is an operator is detected, and a display device close to the location of the user is determined as a display device currently being operated and is selected as an operation target display device being operated. As an example, when one sensor among a plurality of sensors respectively disposed in the plurality of display devices 11 to 13 detects the location of the user (operator), the device selection unit 131 of the display control device 30 selects a display device that the one sensor is disposed as the operation target display device from among the plurality of display devices 11 to 13. In a display system according to the third embodiment, for example, changes from the first embodiment will be described as changes from the first and second embodiments.

### [3.1 Configuration]

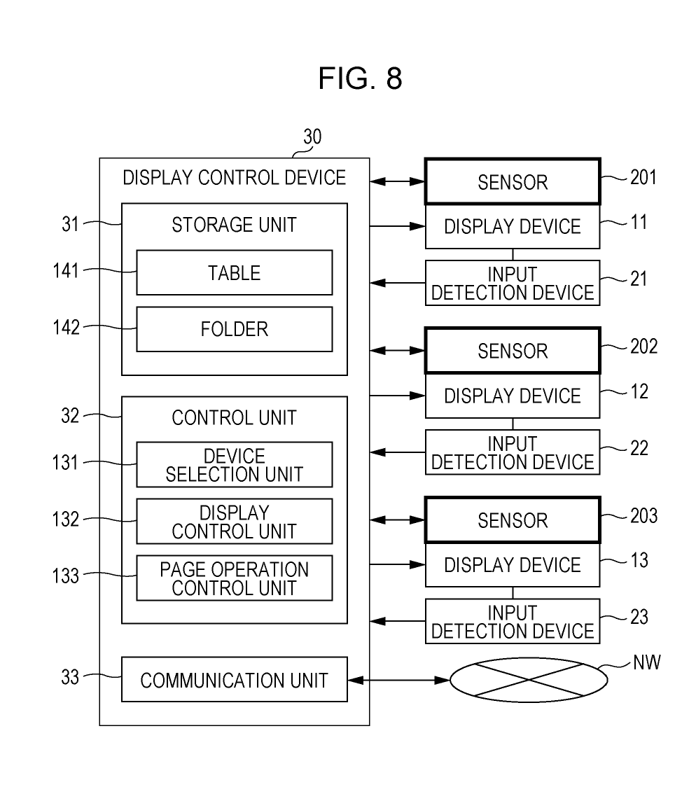

FIG. 8 is a block diagram illustrating a configuration of the display system according to the third embodiment. As illustrated in FIG. 8, the display system further includes the plurality of sensors.

The plurality of sensors are sensors for detecting the location (position) of the user (operator). In the embodiment, the plurality of sensors are three sensors 201 to 203. The plurality of sensors 201 to 203 are disposed respectively in the plurality of display devices 11 to 13. That is, each of the plurality of sensors 201 to 203 has a detectable range set in front of the plurality of display devices 11 to 13 and detects a location of the user when the user moves to the detectable range. For example, a human sensor is used as the plurality of sensors 201 to 203. As the human sensor, an infrared sensor, an ultrasonic sensor, a visible light sensor, and a combination thereof is used.

When one sensor 201 among the plurality of sensors 201 to 203 detects the location of the user, the device selection unit 131 of the display control device 30 selects a display device (for example, display device 11) in which the sensor 201 detecting the location of the user is disposed as the operation target display device from among the plurality of display devices 11 to 13.

### [3.2 Operation Example]

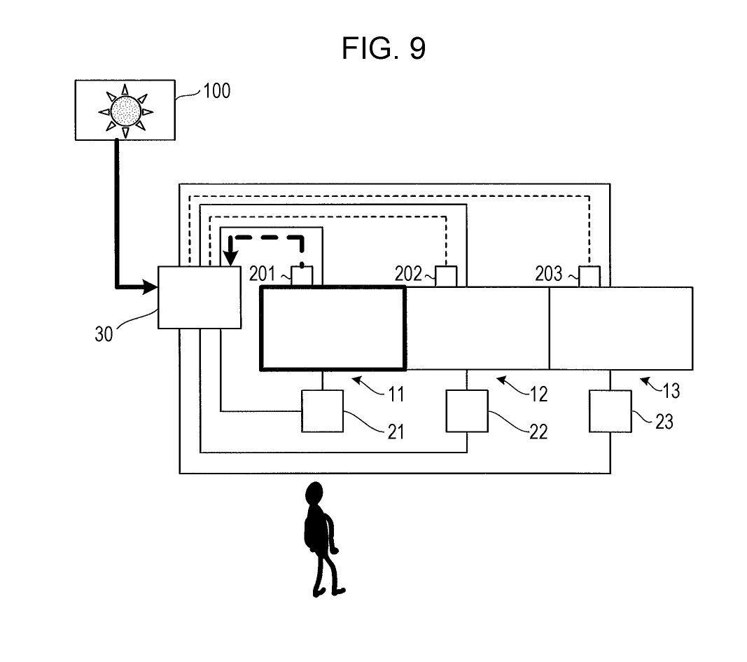

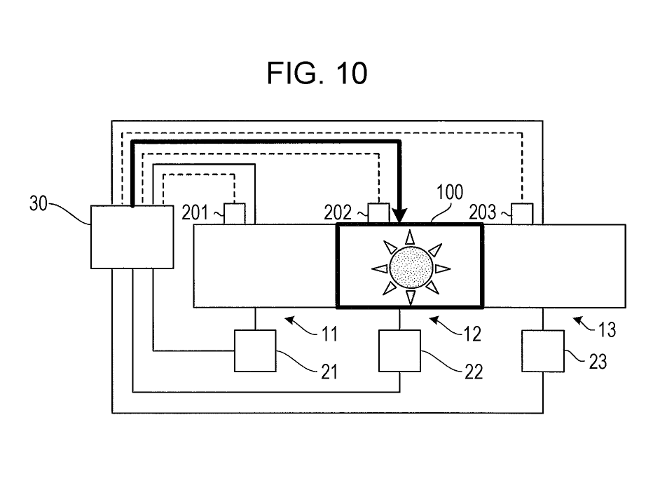

Next, operation examples in the embodiment will be described with reference to drawings. FIGS. 9 and 10 are diagrams for illustrating operation examples of the display system according to the third embodiment.

As illustrated in FIG. 9, for example, it is assumed that a user moves to the detectable range of the display device 11 among the plurality of display devices 11 to 13. At the time, the sensor 201 among the plurality of sensors 201 to 203 detects the location of the user.

As illustrated in FIG. 9, the control unit 32 of the display control device 30 inputs or receives the image data 100 and saves the image data 100 in the folder 142. The device selection unit 131 of the display control device 30 determines the display device 11 which is disposed for the sensor 201 detecting the location of the user as the operation target display device among the plurality of display devices 11 to 13 as the display device in an operation state, and selects the display device 11.

As illustrated in FIG. 10, the device selection unit 131 of the display control device 30 selects a display device (display device 12) disposed adjacent to the right of the operation target display device (display device 11) as the selection display device from among the plurality of display devices 11 to 13. At the time, the display control unit 132 of the display control device 30 displays the image data 100 on the displayable region of the selection display device (display device 12).

As described above, the display system according to the third embodiment includes the plurality of display devices 11 to 13 arranged side by side, the display control device 30 connected to the plurality of display devices 11 to 13, and the plurality of sensors 201 to 203 disposed respectively for the plurality of display devices 11 to 13. The display control device 30 includes the device selection unit 131 and the display control unit 132. When one sensor 201 among the plurality of sensors 201 to 203 detects the location of the user, the device selection unit 131 selects the display device 11 in which the sensor 201 detecting the location of the user is disposed as the operation target display device from among the plurality of display devices 11 to 13 operated by the user. The device selection unit 131 selects one display device (in the case, display device 12) which is different from the operation target display device (display device 11) and arranged adjacent to the right of the operation target display device (display device 11) as the selection display device from among the plurality of display devices 11 to 13. The display control unit 132 displays the received image data 100 on the selection display device (display device 12).

With the display system according to the third embodiment, in order to make the image data 100 for the user (for example, teacher or presenter) or the viewer (for example, student or participant) to view in an easily viewable manner, the image data 100 is displayed on the display device 12 other than a display device close to the position where the user is located. Consequently, in the display system according to the third embodiment, when the received content data is displayed using the plurality of display devices 11 to 13, since the content data is displayed on a display device far from the position of the user, and it is possible to display the data at a position of not disturbing a display being operated.

In the embodiment described above, the sensor is disposed in each display device, but a sensor device detecting the location of the user may be disposed separately in an area in which the display device is disposed. The sensor device may be a sensor capable of detecting the location of the user by space recognition or a system capable of detecting the location of the user by image recognition in an image capturing device. With detecting the position of the user, the display device close to the user is detected, and the processing described above is executed.

### 4. Fourth Embodiment

Next, a fourth embodiment will be described. In the fourth embodiment, the operation target display device is selected by a state of a program being executed. As an example, the device selection unit 131 of the display control device 30 selects a display device on which a menu for a user to operate is displayed as the operation target display device from among the plurality of display devices 11 to 13. In a display system according to the fourth embodiment, for example, changes from the first embodiment will be described as changes from the first to third embodiments.

### [4.1 Operation Example]

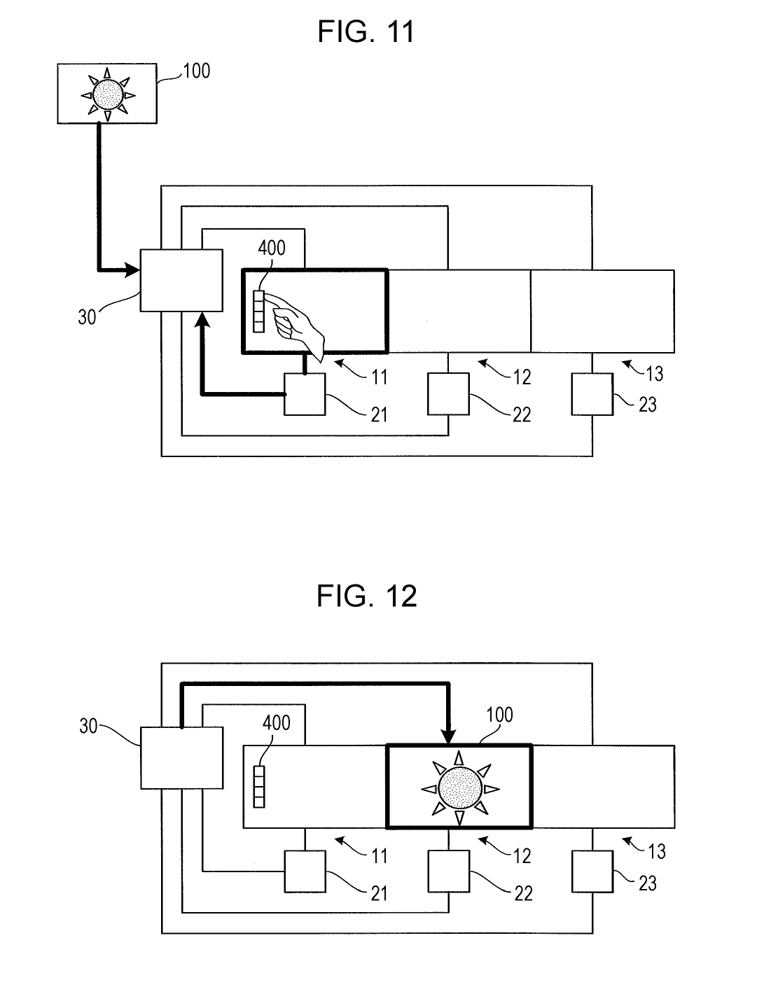

Operation examples in the embodiment will be described with reference to drawings. FIGS. 11 and 12 are diagrams for illustrating operation examples of a display system according to the fourth embodiment.

As illustrated in FIG. 11, for example, it is assumed that a user performs a touch operation for displaying a menu 400 by the fingertip or a pen tip on the display device 11 among the plurality of display devices 11 to 13. As the touch operation for displaying a menu 400, for example, long press is exemplified. At the time, the input detection device 21 among the plurality of input detection devices 21 to 23 detects an input (long press) by the user to the display device 11 as input information. The input information includes the touch operation (long press) and a position (coordinate) specified on the display device 11. The display control unit 132 of the display control device 30 displays the menu 400 at the specification position of the display device 11 in response to the input information.

There are various methods of displaying a menu. The method may be a part menu display capable of selecting processing or a menu display capable of displaying switching of windows in addition to the menu display which is displayed by the operation as in the embodiment.

As illustrated in FIG. 12, the control unit 32 of the display control device 30 inputs or receives the image data 100 and saves the image data 100 in the folder 142. The device selection unit 131 of the display control device 30 selects the display device 11 on which the menu 400 is displayed as the operation target display device from among the plurality of display devices 11 to 13.

As illustrated in FIG. 12, the device selection unit 131 of the display control device 30 selects a display device (display device 12) disposed adjacent to the right of the operation target display device (display device 11) as the selection display device from among the plurality of display devices 11 to 13. At the time, the display control unit 132 of the display control device 30 displays the image data 100 on a displayable region of the selection display device (display device 12).

As described above, the display system according to the fourth embodiment includes the plurality of display devices 11 to 13 arranged side by side, the display control device 30 connected to the plurality of display devices 11 to 13. The display control device 30 includes the device selection unit 131 and the display control unit 132. The device selection unit 131 selects the display device 11 on which the menu 400 for the user to operate is displayed as the operation target display device operated by the user from among the plurality of display devices 11 to 13. The device selection unit 131 selects one display device (in the case, display device 12) which is different from the operation target display device (display device 11) and arranged adjacent to the right of the operation target display device (display device 11) as the selection display device from among the plurality of display devices 11 to 13. The display control unit 132 displays the received image data 100 on the selection display device (display device 12).

With the display system according to the fourth embodiment, in order to make the image data 100 for the user (for example, teacher or presenter) or the viewer (for example, student or participant) to view in an easily viewable manner, the image data 100 is displayed on the display device 12 which is not operated by the user. Consequently, in the display system according to the fourth embodiment, when the received content data is displayed using the plurality of display devices 11 to 13, since the content data is displayed on a display device other than the display device which becomes the operation target from the state of the program, and it is possible to display the data at a position of not disturbing a display being operated.

In the case of selecting the operation target display device from the state of the program being executed, the region (display device) where the menu display is being performed is used, but another module or part may be used.

For example, as an object being displayed, a display device on which a cursor or a pointer is displayed may be selected as the operation target display device, or a display device on which a dialog box is displayed may be selected as the operation target display device.

The operation target display device may be selected not only by the object being displayed, but by a display state. For example, it is assumed that a plurality of programs currently operated are displayed on a plurality of display devices. At the time, a display device (for example, display device on which an active window is displayed) on which a program currently executed is displayed may be selected as the operation target display device.

In such case, for example, even in a case where a user performs, for example, a keyboard operation or a mouse operation other than the touch operation, it is possible to appropriately select the operation target display device.

### 5. Fifth Embodiment

Next, a fifth embodiment will be described. In the fifth embodiment, the device selection unit 131 of the display control device 30 selects at least one display device of display devices on which content data is displayed already as the operation target display device from among the plurality of display devices 11 to 13. In a display system according to the fifth embodiment, for example, changes from the first embodiment will be described as changes from the first to fourth embodiments.

### [5.1 Operation Example]

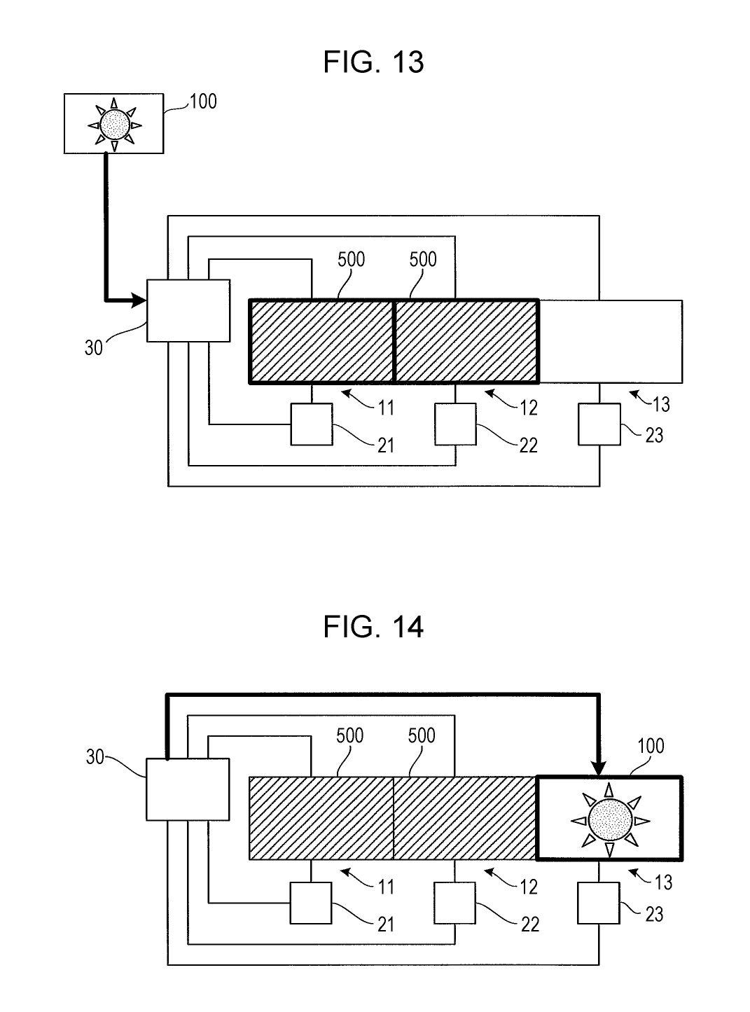

Operation examples in the embodiment will be described with reference to drawings. FIGS. 13 and 14 are diagrams for illustrating operation examples of a display system according to a fifth embodiment.

As illustrated in FIG. 13, the display control unit 132 of the display control device 30 displays a content data 500 on the display devices 11 and 12. The content data 500 displays, for example, content which is downloaded through a network. The content data 500 is a character, a figure, a voice, an image, a moving image, a web page, or a combination thereof. For example, the content data 500 is configured to have data of a plurality of pages, and the display control unit 132 of the display control device 30 displays data of two pages on display devices 11 and 12, respectively in a slide form.

As illustrated in FIG. 13, the control unit 32 of the display control device 30 inputs or receives the image data 100 and saves the image data 100 in the folder 142. The device selection unit 131 of the display control device 30 selects the display devices 11 and 12 on which the content data 500 is displayed already as the operation target display device from among the plurality of display devices 11 to 13.

As illustrated in FIG. 14, the device selection unit 131 of the display control device 30 selects the display device 13 other than the operation target display device (display devices 11, 12) as the selection display device. That is, the display device 13 arranged adjacent to the right of the operation target display device (display devices 11 and 12) is selected as the selection display device. At the time, the display control unit 132 of the display control device 30 displays the image data 100 on a displayable region of the selection display device (display device 13).

A display device on which the received content data is not displayed (selection display device) includes a case where no content data is displayed and a case where a content data currently used is not displayed.

For example, it is assumed that image data previously used is displayed on the display device 12 while reproducing moving image data in the display device 11. In the case, only the display device 13 on which no content data is displayed may be selected as the selection display device, or the display device 12 and the display device 13 in which the moving image data are not reproduced may be selected as the selection display device.

A state where the content data is not displayed may be a state where content data being used by a user (for example, moving image data or data for presentation) is not displayed. That is, a case where content data such as a desktop icon or a clock display is displayed may be included the state where the content data is not displayed.

As described above, the display system according to the fifth embodiment includes the plurality of display devices 11 to 13 arranged side by side, the display control device 30 connected to the plurality of display devices 11 to 13. The display control device 30 includes the device selection unit 131 and the display control unit 132. The device selection unit 131 selects the display devices 11 and 12 on which the content data 500 is displayed as the operation target display device operated by the user from among the plurality of display devices 11 to 13. The device selection unit 131 selects one display device (in the case, display device 13) which is different from the operation target display device (display device 11) and arranged adjacent to the right of the operation target display device (display devices 11 and 12) as the selection display device from among the plurality of display devices 11 to 13. The display control unit 132 displays the received image data 100 on the selection display device (display device 13).

With the display system according to the fifth embodiment, in order to make the image data 100 for the user (for example, teacher or presenter) or the viewer (for example, student or participant) to view in an easily viewable manner, the image data 100 is displayed on the display device 13 other than the display device on which the content data is displayed already. Consequently, in the display system according to the fifth embodiment, when the received content data is displayed using the plurality of display devices 11 to 13, since the received content data can be displayed on the display device on which the content data is not displayed, and it is possible to display the received content data at a position of not disturbing a display of the content data which is displayed already.

### 6. Sixth Embodiment

Next, a sixth embodiment will be described. In the sixth embodiment, the device selection unit 131 of the display control device 30 selects the operation target display device and the selection display device from among the plurality of display devices 11 to 13 based on a history when a user touches the plurality of display devices 11 to 13. In a display system according to the sixth embodiment, for example, changes from the first embodiment will be described as changes from the first to fifth embodiments.

### [6.1 Configuration]

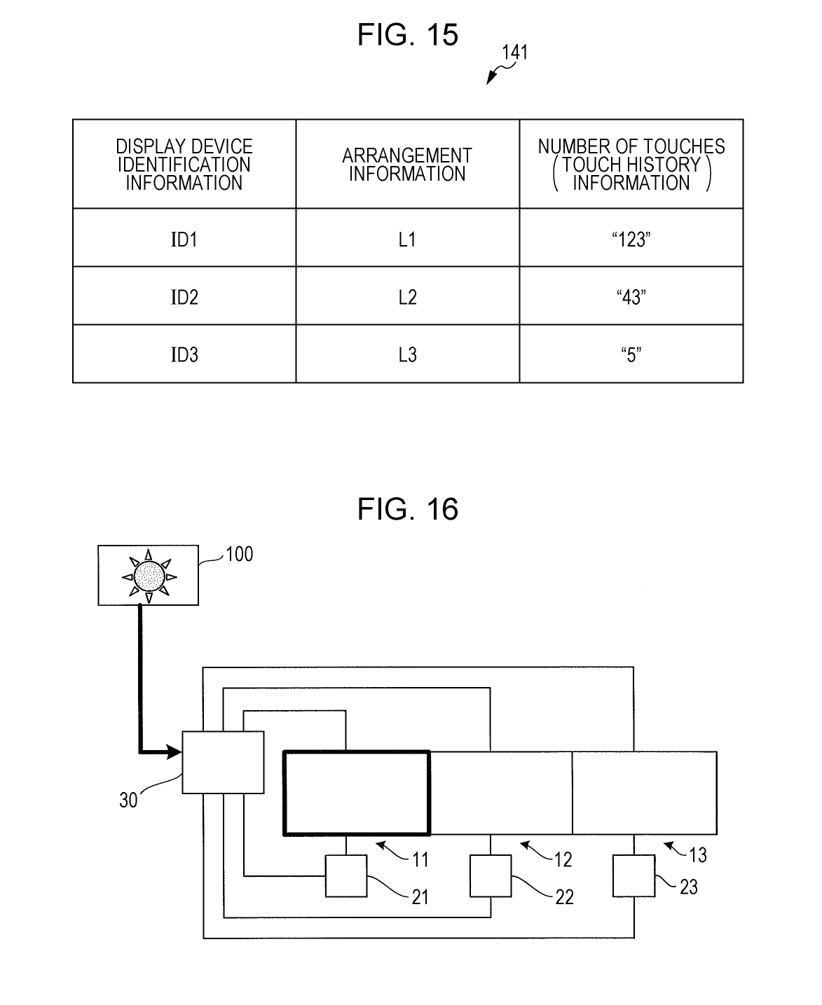

FIG. 15 is a diagram illustrating a table 141 of the display control device 30 of a display system according to the sixth embodiment. As illustrated in FIG. 15, the table 141 further stores touch history information. The touch history information represents the history when the user touches each of the plurality of display devices 11 to 13.

As described above, each of the plurality of input detection devices 21 to 23 detects an input of the user to the plurality of display devices 11 to 13 as input information. When the device selection unit 131 of the display control device 30 receives the input information from the plurality of input detection devices 21 to 23, the number of touches of the user on the plurality of display devices 11 to 13 is stored in the table 141 as the touch history information.

For example, it is assumed that the user performs a touch operation for inputting a character by the fingertip or a pen tip on the display device 11 among the plurality of display devices 11 to 13. At the time, the input detection device 21 among the plurality of input detection devices 21 to 23 detects the input of the user to the display device 11 as the input information. In the case, when the input information is received from the input detection device 21, the device selection unit 131 of the display control device 30 adds “1” to the number of touches of the user on the display device 11 which is also the touch history information stored in the table 141. It is assumed that the table 141 currently stores “123”, “43”, and “5” as the number of touches of the user on the plurality of display devices 11 to 13, respectively.

The number of touches (touch history information) may be the accumulative number of touches in a currently executed program or may be the number of touches within a predetermined time. The number of touches may be clear at a timing of displaying image data or be clear at an arbitrary timing by the user.

### [6.2 Operation Example]

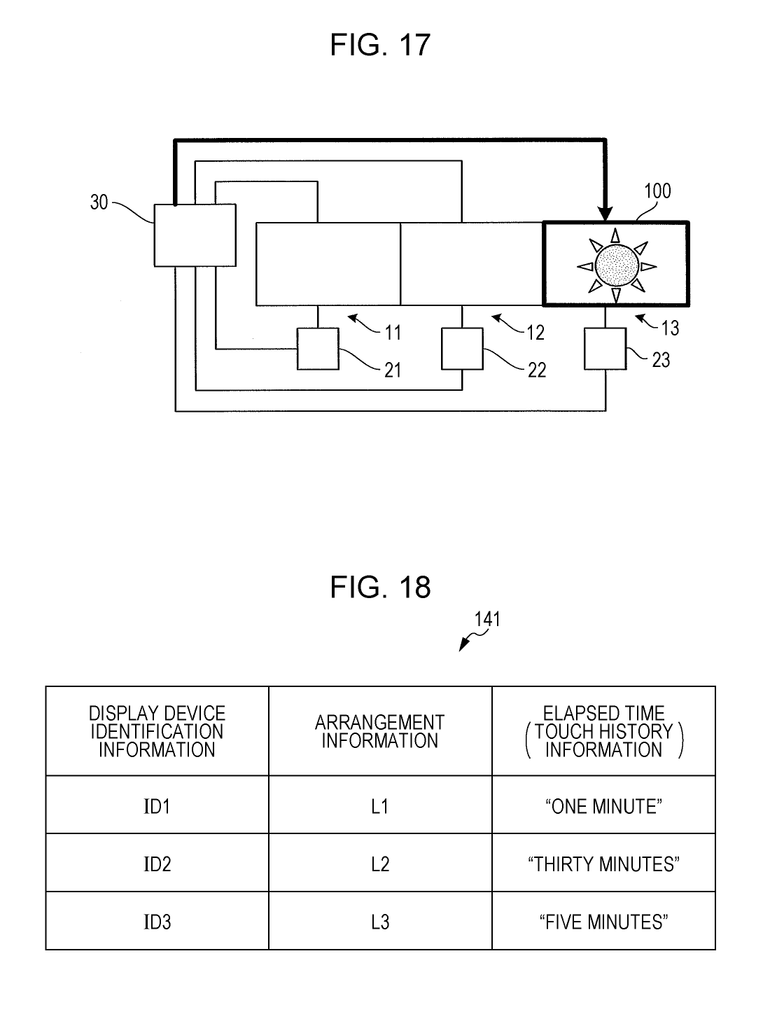

Operation examples in the embodiment will be described with reference to drawings. FIGS. 16 and 17 are diagrams for illustrating operation examples of the display system according to the sixth embodiment.

As illustrated in FIG. 16, the control unit 32 of the display control device 30 inputs or receives the image data 100 and saves the image data 100 in the folder 142. The device selection unit 131 of the display control device 30 selects a display device 11 having the highest number of touches by the user as the operation target display device from among the plurality of display devices 11 to 13 with reference to the touch history information stored in the table 141.

A display device other than the operation target display device is selected as the selection display device and the image data is displayed on the display device.

As illustrated in FIG. 17, the device selection unit 131 of the display control device 30 may further select the display device 13 having the lowest number of touches by the user as the selection display device from among the plurality of display devices 11 to 13 with reference to the touch history information stored in the table 141. At the time, the display control unit 132 of the display control device 30 displays the image data 100 on a displayable region of the selection display device (display device 13).

In display devices selected as the operation target display device and the selection display device, the number of touches may be set by the user. For example, when there is a demand that the user wants to display a static content on the display device having the lowest number of touches or the like, a display device having the second lowest of touches may be set as the selection display device.

As described above, the display system according to the sixth embodiment includes the plurality of display devices 11 to 13 arranged side by side, the display control device 30 connected to the plurality of display devices 11 to 13. The display control device 30 includes the device selection unit 131 and the display control unit 132. The device selection unit 131 selects the operation target display device operated by the user and the selection display device for displaying the image data 100 from among the plurality of display devices 11 to 13 based on the history when the user touches the plurality of display devices 11 to 13. Specifically, the device selection unit 131 selects one display device (display device 11) having the highest number of touches by the user as the operation target display device and one display device (display device 13) having the lowest number of touches by the user as the selection display device from among the plurality of display devices 11 to 13. The display control unit 132 displays the received image data 100 on the selection display device (display device 13).

With the display system according to the sixth embodiment, in order to make the image data 100 for the user (for example, teacher or presenter) or the viewer (for example, student or participant) to view in an easily viewable manner, the image data 100 is displayed on the display device 13 which is not operated by the user. Consequently, in the display system according to the sixth embodiment, when the received content data is displayed using the plurality of display devices 11 to 13, since the received content data is displayed on the display device which is not operated most by the user from the number of touch histories, and it is possible to display the data at a position of not disturbing a display being operated.

### 7. Seventh Embodiment

Next, a seventh embodiment will be described. In the sixth embodiment, the device selection unit 131 of the display control device 30 selects the operation target display device and the selection display device based on the number of touches by the user from among the plurality of display devices 11 to 13, but the selection is performed using the elapsed time in the seventh embodiment. For example, in the embodiment, the device selection unit 131 of the display control device 30 selects a display device having the shortest elapsed time after the last touch by the user as the operation target display device, and a display device having the longest elapsed time after the last touch by the user as the selection display device from among the plurality of display devices 11 to 13. In a display system according to the seventh embodiment, for example, changes from the sixth embodiment will be described as changes from the first to sixth embodiments.

### [7.1 Configuration]

FIG. 18 is a diagram illustrating a table 141 of the display control device 30 of a display system according to the seventh embodiment.

As described above, each of the plurality of input detection devices 21 to 23 detects an input of the user to the plurality of display devices 11 to 13 as input information. When the device selection unit 131 of the display control device 30 does not receive the input information from the plurality of input detection devices 21 to 23, elapsed time for each of the plurality of display devices 11 to 13 is stored in the table 141 as the touch history information.

For example, it is assumed that the user performs a touch operation for inputting a character by the fingertip or a pen tip is performed on the display device 11 among the plurality of display devices 11 to 13. At the time, the input detection device 21 among the plurality of input detection devices 21 to 23 detects the input of the user to the display device 11 as the input information. In the case, when the input information is received from the input detection device 21, the device selection unit 131 of the display control device 30 clears the elapsed time for the display device 11 which is also the touch history information stored in the table 141. That is, the elapse time becomes “zero”. It is assumed that the table 141 currently stores “one minute”, “thirty minutes”, and “five minutes” as the elapsed time for the plurality of display devices 11 to 13, respectively.

### [7.2 Operation Example]

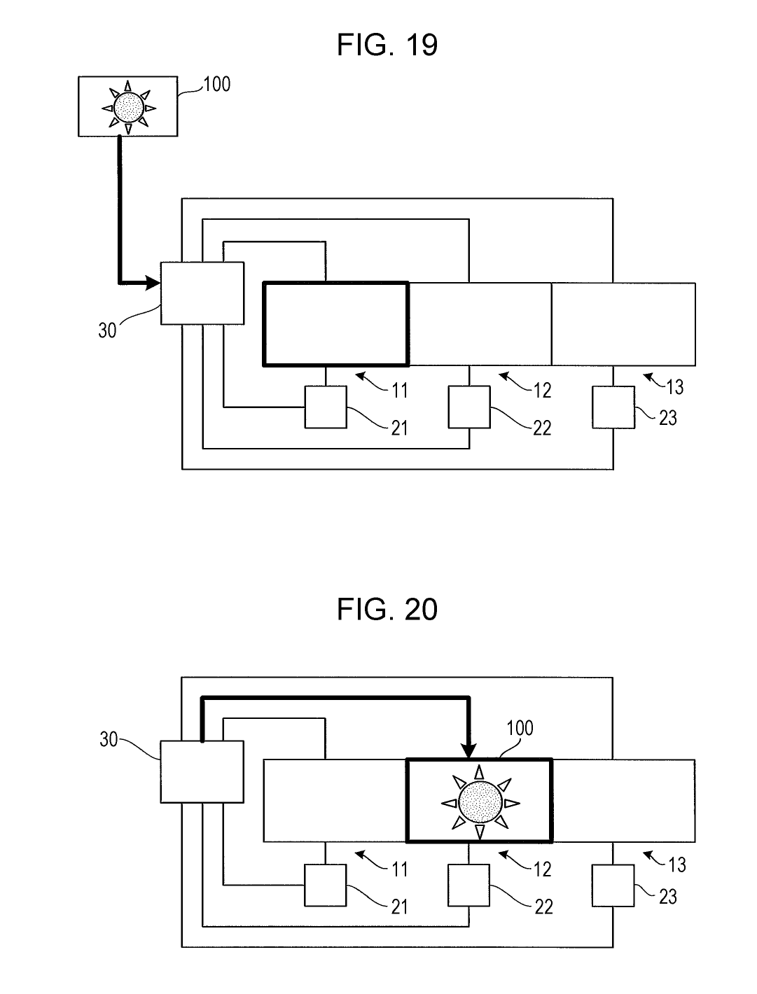

Operation examples in the embodiment will be described with reference to drawings. FIGS. 19 and 20 are diagrams for illustrating operation examples of the display system according to the seventh embodiment.

As illustrated in FIG. 19, the control unit 32 of the display control device 30 inputs or receives the image data 100 and saves the image data 100 in the folder 142. The device selection unit 131 of the display control device 30 selects a display device 11 having the shortest elapsed time after the last touch by the user as the operation target display device from among the plurality of display devices 11 to 13 with reference to the touch history information stored in the table 141.

As illustrated in FIG. 20, the device selection unit 131 of the display control device 30 selects a display device 12 having the longest elapsed time after the last touch by the user as the selection display device from among the plurality of display devices 11 to 13 with reference to the touch history information stored in the table 141. At the time, the display control unit 132 of the display control device 30 displays the image data 100 on a displayable region of the selection display device (display device 12).

In display devices selected as the operation target display device and the selection display device, the elapsed time may be set by the user. For example, when there is a demand that the user wants to display a static content on the display device having the longest elapsed time or the like, a display device having the second longest elapsed time may be set as the selection display device.

As described above, the display system according to the seventh embodiment includes the plurality of display devices 11 to 13 arranged side by side, the display control device 30 connected to the plurality of display devices 11 to 13. The display control device 30 includes the device selection unit 131 and the display control unit 132. The device selection unit 131 selects the operation target display device operated by the user and the selection display device for displaying the image data 100 from among the plurality of display devices 11 to 13 based on the history when the user touches the plurality of display devices 11 to 13. Specifically, the device selection unit 131 selects one display device (display device 11) having the shortest elapsed time after the last touch by the user as the operation target display device and one display device (display device 12) having the longest elapsed time after the last touch by the user as the selection display device from among the plurality of display devices 11 to 13. The display control unit 132 displays the received image data 100 on the selection display device (display device 12).

With the display system according to the seventh embodiment, in order to make the image data 100 for the user (for example, teacher or presenter) or the viewer (for example, student or participant) to view in an easily viewable manner, the image data 100 is displayed on the display device 12 which is not operated by the user. Consequently, in the display system according to the seventh embodiment, when the received content data is displayed using the plurality of display devices 11 to 13, since the content data is displayed on the display device which is not operated for a long time by the user, and it is possible to display the data at a position of not disturbing a display being operated.

The sixth embodiment and the seventh embodiment may be combined. For example, the device selection unit 131 of the display control device 30 may select the display device 11 having the highest number of touches by the user as the operation target display device and the display device 12 having the longest elapsed time after the last touch by the user as the selection display device from among the plurality of display devices 11 to 13. The device selection unit 131 of the display control device 30 may select the display device 11 having the shortest elapsed time after the last touch by the user as the operation target display device and the display device 13 having the lowest number of touches by the user as the selection display device among the plurality of display devices 11 to 13.

### 8. Eighth Embodiment

Next, an eighth embodiment will be described. In the eighth embodiment, a notification screen representing that when image data is input or received is displayed on a plurality of display devices to notify a user. At the time, the device selection unit 131 of the display control device 30 selects a display device specified by the user as the selection display device and a display device other than the selection display device as the operation target display device from among the plurality of display devices 11 to 13 on which the notification screens are displayed, and the display control unit displays the image data on the selection display device. In a display system according to the eighth embodiment, for example, changes from the first embodiment will be described as changes from the first to seventh embodiments.

### [8.1 Configuration]

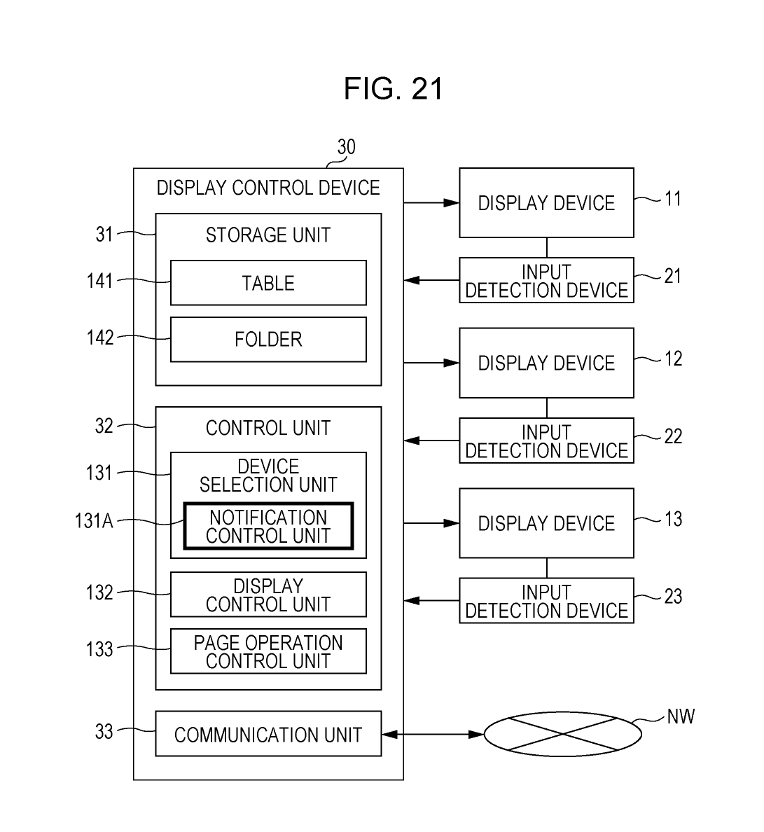

FIG. 21 is a block diagram illustrating a configuration of the display system according to the eighth embodiment.

The device selection unit 131 of the display control device 30 selects a display device operated by a user as the operation target display device from among the plurality of display devices 11 to 13. Specifically, as illustrated in FIG. 21, the device selection unit 131 includes a notification control unit 131A, and when the image data is input or received (when the input or received image data is saved in the folder 142), the notification control unit 131A notifies the user of that fact by the plurality of display devices 11 to 13. The device selection unit 131 selects a display device specified by the user with the notification as the selection display device from among the plurality of display devices 11 to 13.

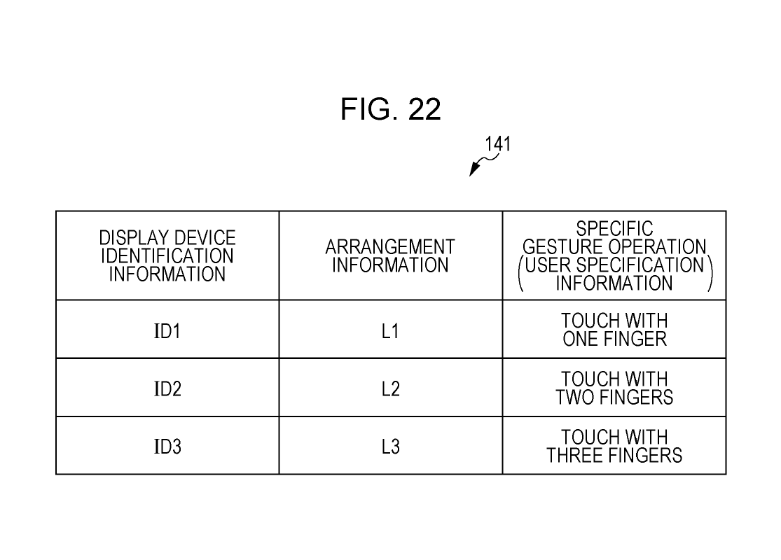

FIG. 22 is a diagram illustrating a table 141 of the display control device 30 of the display system according to the eighth embodiment. As illustrated in FIG. 22, the table 141 further stores user specification information. The user specification information represents a specific gesture operation assigned to each of the plurality of display devices 11 to 13. For example, a specific gesture operation assigned to the display device 11 is a touch with one finger. A specific gesture operation assigned to the display device 12 is a touch with two fingers. A specific gesture operation assigned to the display device 13 is a touch with three fingers.

### [8.2 Processing Flow]

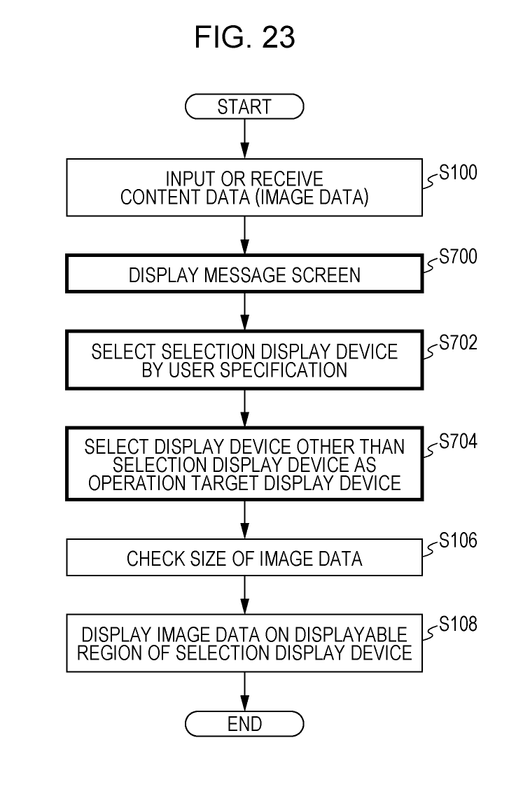

Next, a processing flow according to the embodiment will be described with reference to a drawing. FIG. 23 is a flowchart illustrating an operation (display processing) of the display system according to the eighth embodiment.

In the display control device 30, the control unit 32 inputs or receives the image data (step S100). At the time, the control unit 32 saves the image data in the folder 142. The notification control unit 131A of the device selection unit 131 displays the notification screen representing that the image data 100 is input or received on the plurality of display devices 11 to 13 to notify the user (step S700). The notification screen is a message screen for notifying by a message that the image data is input or received.

When the user performs a specific gesture operation on a message screen of any one display device among the plurality of display devices 11 to 13, the display device assigned to the specific gesture operation performed by the user is selected as the selection display device from among the plurality of display devices 11 to 13 on which the message screen is displayed (step S702). The device selection unit 131 selects a display device other than the selection display device as the operation target display device (step S704).

The display control unit 132 checks a size of the image data (step S106). The display control unit 132 displays the image data on a displayable region of the selection display device (step S108).

### [8.3 Operation Example]

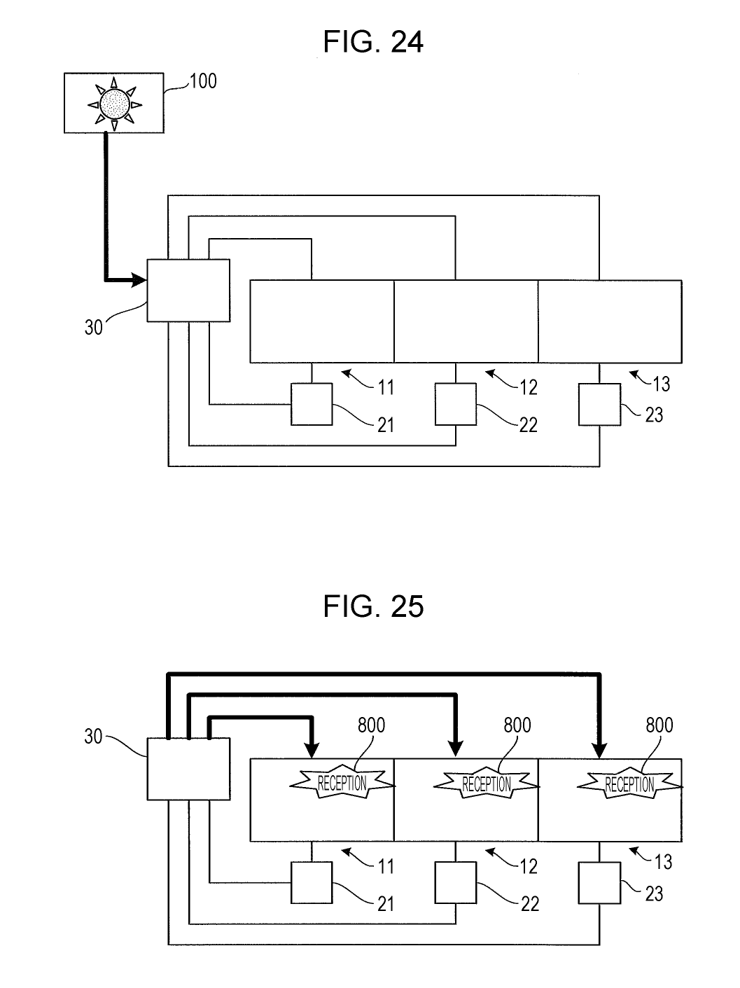

Operation examples in the embodiment will be described with reference to drawings. FIGS. 24 to 27 are diagrams for illustrating operation examples of the display system according to the eighth embodiment.

As illustrated in FIG. 24, the control unit 32 of the display control device 30 inputs or receives the image data 100 and saves the image data 100 in the folder 142.

At the time, as illustrated in FIG. 25, the notification control unit 131A of the device selection unit 131 displays a message screen 800 on the plurality of display devices 11 to 13 for notifying the user by the message that the image data 100 is input or received.

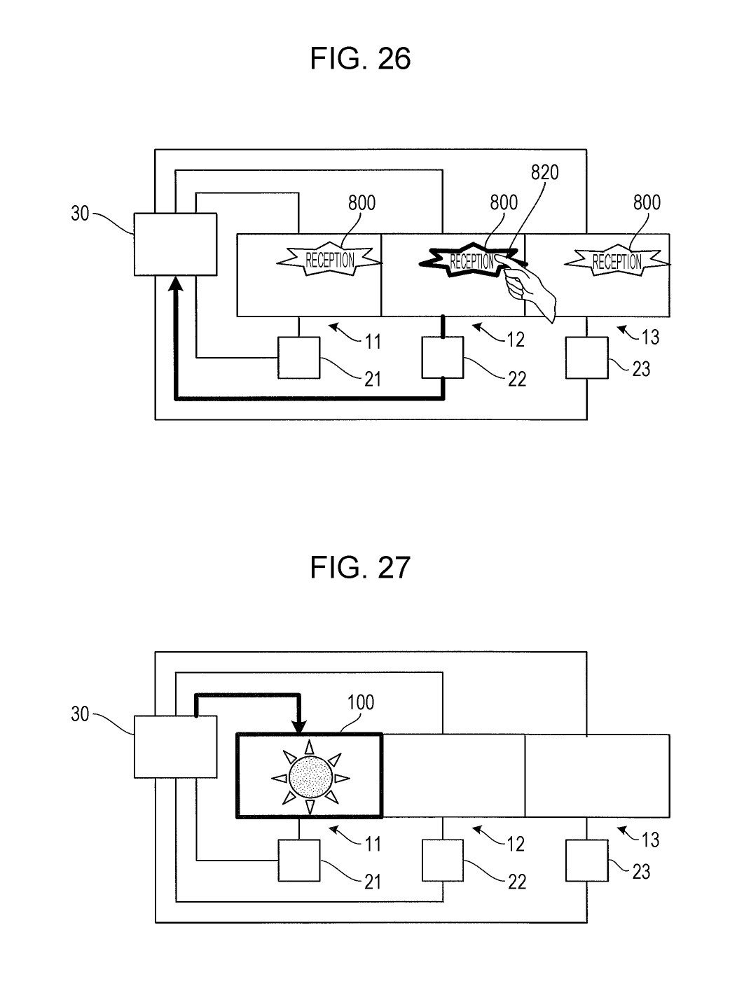

For example, as illustrated in FIG. 26, it is assumed that the user performs a specific gesture operation by the touch with one finger on the message screen 800 on the display device 12 among the plurality of display devices 11 to 13. At the time, the input detection device 22 among the plurality of input detection devices 21 to 23 detects the input of the user to the display device 12 as the input information. When the input information is received from the input detection device 22, in a case where the input information represents the specific gesture operation by the touch with one finger, the device selection unit 131 of the display control device 30 selects the display device 11 assigned to the specific gesture operation as the selection display device from among the plurality of display devices 11 to 13.

As illustrated in FIG. 27, the device selection unit 131 of the display control device 30 selects the display devices 12 and 13 other than the selection display device (display device 11) as the operation target display device. At the time, the display control unit 132 of the display control device 30 displays the image data 100 on a displayable region of the selection display device (display device 11).

As described above, the display system according to the eighth embodiment includes the plurality of display devices 11 to 13 arranged side by side, the display control device 30 connected to the plurality of display devices 11 to 13. The display control device 30 includes the notification control unit 131A, the device selection unit 131, and the display control unit 132. The notification control unit 131A displays a message screen 800, when image data is received, on the plurality of display devices 11 to 13 to which each specific operation is assigned for notifying the user by the message that the image data is input or received. The specific gesture operations (touch with one finger, touch with two fingers, and touch with three fingers) as the specific operation are assigned to each of the plurality of display devices 11 to 13. When the user performs the specific gesture operation (touch with one finger) on the message screen 800 of one display device (display device 12) among the plurality of display devices 11 to 13, the device selection unit 131 selects the display device 11 assigned to the specific gesture operation (touch with one finger) performed by the user as the selection display device specified by the user from among the plurality of display devices 11 to 13. The device selection unit 131 selects the display devices 12 and 13 other than the selection display device (display device 11) as the operation target display device. The display control unit 132 displays the received image data 100 on the selection display device (display device 11). Here, the display device (display device 12) in which the specific gesture operation (touch with one finger) is performed by the user is different from the display device (display device 11) which is selected as the selection display device by the specific gesture operation (touch with one finger) of the user.

With the display system according to the eighth embodiment, in order to make the image data 100 for the user (for example, teacher or presenter) or the viewer (for example, student or participant) to view in an easily viewable manner, the image data 100 is displayed on the display device 11 which is not operated by the user. Consequently, in the display system according to the eighth embodiment, when the image data 100 is displayed using the plurality of display devices 11 to 13, since the received image data 100 can be displayed at the position intended by the user, and it is possible to display the data at a position of not disturbing a display being operated.

### 9. Ninth Embodiment

Next, a ninth embodiment will be described. In the eighth embodiment, the device selection unit 131 of the display control device 30 selects the display device assigned to the specific gesture operation performed by the user as the selection display device from among the plurality of display devices 11 to 13, but the present disclosure is not limited thereto. For example, in the ninth embodiment, the device selection unit 131 of the display control device 30 selects a display device assigned to a unique character which is input by a user as the selection display device from among the plurality of display devices 11 to 13. In a display system according to the ninth embodiment, for example, changes from the eighth embodiment will be described as changes from the first to eighth embodiments.

### [9.1 Configuration]

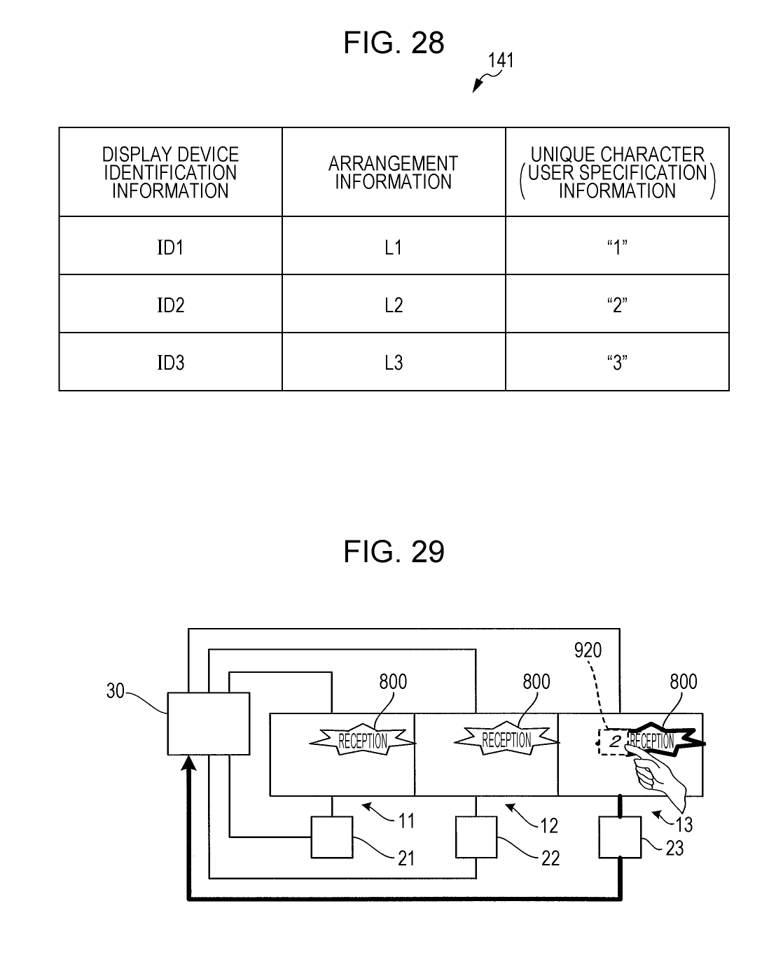

FIG. 28 is a diagram illustrating a table 141 of the display control device 30 of a display system according to the ninth embodiment.

As illustrated in FIG. 28, the table 141 further stores user specification information. The user specification information represents a unique character assigned to each of the plurality of display devices 11 to 13. For example, the unique character assigned to the display device 11 is “1”. The unique character assigned to the display device 12 is “2”. The unique character assigned to the display device 13 is “3”.

### [9.2 Operation Example]

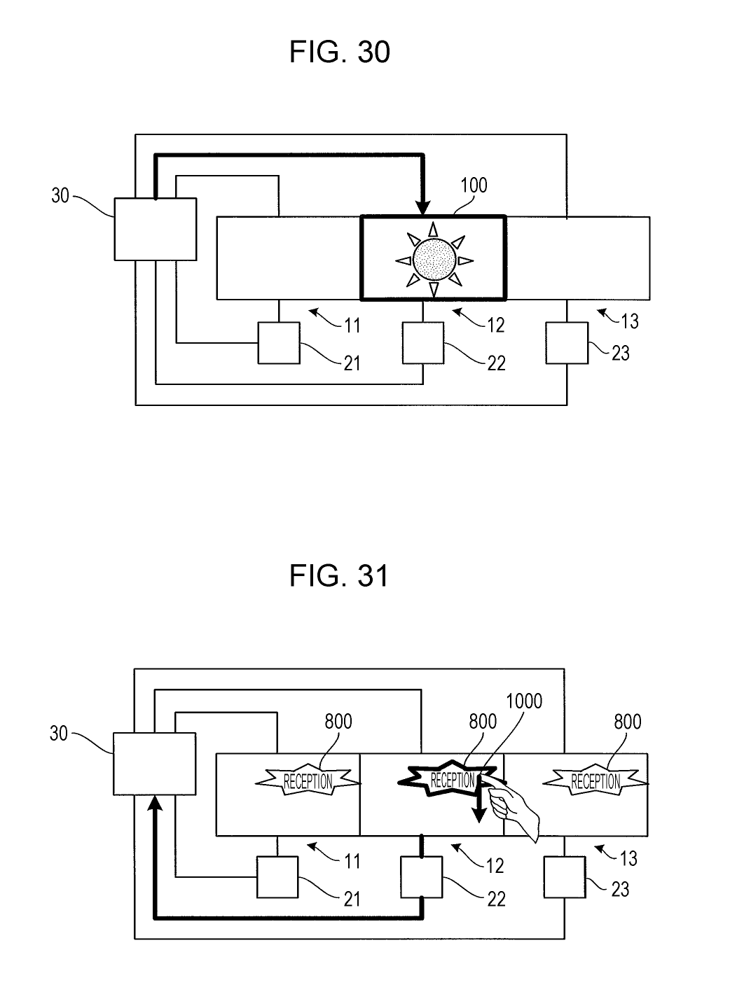

Operation examples in the embodiment will be described with reference to drawings. FIGS. 29 and 30 are diagrams for illustrating operation examples of the display system according to the ninth embodiment.

The control unit 32 of the display control device 30 inputs or receives the image data 100 (refer to FIG. 24) and saves the image data 100 in the folder 142. At the time, the notification control unit 131A of the device selection unit 131 displays the message screen 800 (refer to FIG. 25) on the plurality of display devices 11 to 13 for notifying the user by the message that the image data 100 is input or received.

For example, as illustrated in FIG. 29, it is assumed that the user inputs a unique character “2” to the message screen 800 on the display device 13 among the plurality of display devices 11 to 13. At the time, the input detection device 23 among the plurality of input detection devices 21 to 23 detects the input of the user to the display device 13 as the input information. When the input information is received from the input detection device 23, in a case where the input information represents the unique character “2”, the device selection unit 131 of the display control device 30 selects the display device 12 assigned to the unique character “2” as the selection display device from among the plurality of display devices 11 to 13.

As illustrated in FIG. 30, the device selection unit 131 of the display control device 30 selects the display devices 11 and 13 other than the selection display device (display device 12) as the operation target display device. At the time, the display control unit 132 of the display control device 30 displays the image data 100 on a displayable region of the selection display device (display device 12).

As described above, the display system according to the ninth embodiment includes the plurality of display devices 11 to 13 arranged side by side, the display control device 30 connected to the plurality of display devices 11 to 13. The display control device 30 includes the notification control unit 131A, the device selection unit 131, and the display control unit 132. When the image data is input or received, the notification control unit 131A displays the message screen 800 on the plurality of display devices 11 to 13 to which each specific operation is assigned for notifying the user by the message that the image data is input or received. The inputs of the unique characters “1”, “2”, and “3” as the specific operation are assigned to each of the plurality of display devices 11 to 13. When the user performs the input of the unique character “2” on the message screen 800 of the display device (display device 13) among the plurality of display devices 11 to 13, the device selection unit 131 selects the display device 12 assigned to the unique character “2” input by the user as the selection display device specified by the user from among the plurality of display devices 11 to 13. The device selection unit 131 selects the display devices 11, 13 other than the selection display device (display device 12) as the operation target display device. The display control unit 132 displays the received image data 100 on the selection display device (display device 12). Here, the display device (display device 13) in which the input of the unique character “2” is performed by the user is different from the display device (display device 12) which is selected as the selection display device by the input of the unique character “2” of the user.

With the display system according to the ninth embodiment, in order to make the image data 100 for the user (for example, teacher or presenter) or the viewer (for example, student or participant) to view in an easily viewable manner, the image data 100 is displayed on the display device 12 which is not operated by the user. Consequently, in the display system according to the ninth embodiment, when the received content data is displayed using the plurality of display devices 11 to 13, since the user can select the display device of the content data, and it is possible to display the data at a position of not disturbing a display being operated.

### 10. Tenth Embodiment

Next, a tenth embodiment will be described. In the tenth embodiment, the device selection unit 131 of the display control device 30 selects the display device in response to a specific flick operation performed by a user as the selection display device from among the plurality of display devices 11 to 13. In a display system according to the tenth embodiment, for example, changes from the eighth embodiment will be described as changes from the first to ninth embodiments.

As the specific flick operation, a flick to the bottom, a flick to the left, and a flick to the right are exemplified. In a case where the specific flick operation performed on the message screen 800 is the flick to the bottom, the device selection unit 131 of the display control device 30 selects a display device on which the specific flick operation is performed as the selection display device from among the plurality of display devices 11 to 13. In a case where the specific flick operation performed on the message screen 800 is the flick to the left, the device selection unit 131 of the display control device 30 selects a display device arranged adjacent to the left of the display device on which the specific flick operation is performed as the selection display device from among the plurality of display devices 11 to 13. In a case where the specific flick operation performed on the message screen 800 is the flick to the right, the device selection unit 131 of the display control device 30 selects a display device arranged adjacent to the right of the display device on which the specific flick operation is performed as the selection display device from among the plurality of display devices 11 to 13.

### [10.1 First Operation Example]

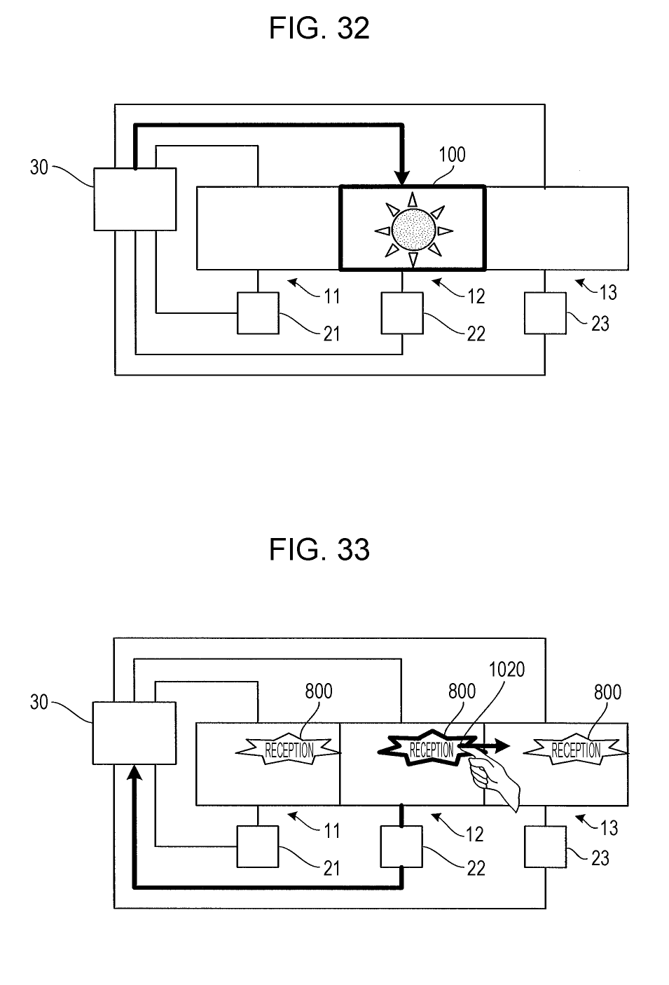

FIGS. 31 and 32 are diagrams for illustrating a first operation example of the display system according to a tenth embodiment.

The control unit 32 of the display control device 30 inputs or receives the image data 100 (refer to FIG. 24) and saves the image data 100 in the folder 142. At the time, the notification control unit 131A of the device selection unit 131 displays the message screen 800 (refer to FIG. 25) on the plurality of display devices 11 to 13 for notifying the user by the message that the image data 100 is input or received.

For example, as illustrated in FIG. 31, it is assumed that the user performs the flick to the bottom as a specific flick operation 1000 on the message screen 800 of the display device 12 among the plurality of display devices 11 to 13. At the time, the input detection device 22 among the plurality of input detection devices 21 to 23 detects the input of the user to the display device 12 as the input information. When the input information is received from the input detection device 22, in a case where the input information represents the specific flick operation 1000 (flick to the bottom), the device selection unit 131 of the display control device 30 selects the display device 12 on which the specific flick operation 1000 is performed as the selection display device from among the plurality of display devices 11 to 13.

As illustrated in FIG. 32, the device selection unit 131 of the display control device 30 selects the display devices 11 and 13 other than the selection display device (display device 12) as the operation target display device. At the time, the display control unit 132 of the display control device 30 displays the image data 100 on a displayable region of the selection display device (display device 12).

### [10.2 Second Operation Example]

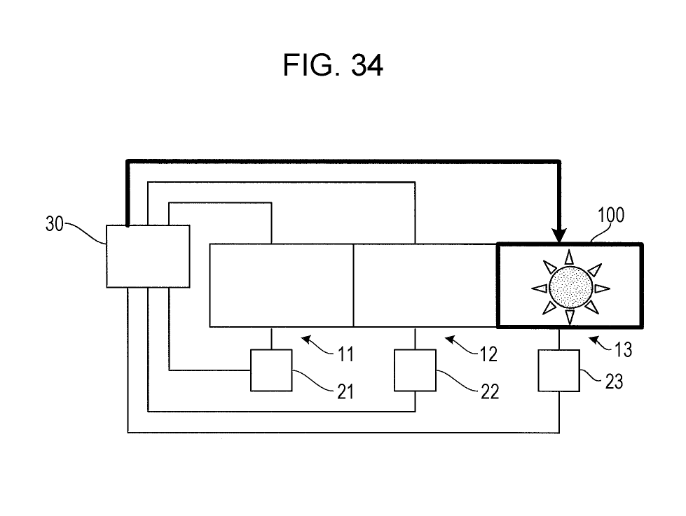

FIGS. 33 and 34 are diagrams for illustrating a second operation example of the display system according to the tenth embodiment.

The control unit 32 of the display control device 30 inputs or receives the image data 100 (refer to FIG. 24) and saves the image data 100 in the folder 142. At the time, the notification control unit 131A of the device selection unit 131 displays the message screen 800 (refer to FIG. 25) on the plurality of display devices 11 to 13 for notifying the user by the message that the image data 100 is input or received.

For example, as illustrated in FIG. 33, it is assumed that the user performs the flick to the right as a specific flick operation 1020 on the message screen 800 of the display device 12 among the plurality of display devices 11 to 13. At the time, the input detection device 22 among the plurality of input detection devices 21 to 23 detects the input of the user to the display device 12 as the input information. When the input information is received from the input detection device 22, in a case where the input information represents the specific flick operation 1020 (flick to the right), the device selection unit 131 of the display control device 30 selects the display device 13 arranged adjacent to the right of the display device 12 on which the specific flick operation 1020 is performed as the selection display device from among the plurality of display devices 11 to 13.

As illustrated in FIG. 34, the device selection unit 131 of the display control device 30 selects the display devices 11 and 12 other than the selection display device (display device 13) as the operation target display device. At the time, the display control unit 132 of the display control device 30 displays the image data 100 on a displayable region of the selection display device (display device 13).

As described above, the display system according to the tenth embodiment includes the plurality of display devices 11 to 13 arranged side by side, the display control device 30 connected to the plurality of display devices 11 to 13. The display control device 30 includes the notification control unit 131A, the device selection unit 131, and the display control unit 132. When the image data is input or received, the notification control unit 131A displays the message screen 800 on the plurality of display devices 11 to 13 to which each specific operation is assigned for notifying the user by the message that the image data is input or received. The specific flick operations (flick to the bottom, flick to the left, and flick to the right) as the specific operation are assigned to each of the plurality of display devices 11 to 13. When the user performs the specific flick operation (flick to the right) on the message screen 800 of the display device (display device 12) among the plurality of display devices 11 to 13, the device selection unit 131 selects the display device 13 assigned to the specific flick operation (flick to the right) performed by the user as the selection display device specified by the user from among the plurality of display devices 11 to 13. The device selection unit 131 selects the display devices 11, 12 other than the selection display device (display device 13) as the operation target display device. The display control unit 132 displays the received image data 100 on the selection display device (display device 13). Here, the display device (display device 12) on which the specific flick operation (flick to the right) is performed by the user is different from the display device (display device 13) which is selected as the selection display device by the specific flick operation (flick to the right) of the user.

With the display system according to the tenth embodiment, in order to make the image data 100 for the user (for example, teacher or presenter) or the viewer (for example, student or participant) to view in an easily viewable manner, the image data 100 is displayed on the display device 12 or the display device 13 which is not operated by the user. Consequently, in the display system according to the tenth embodiment, when the received content data is displayed using the plurality of display devices 11 to 13, since the user can select the position for displaying the content data, and it is possible to display the data at a position of not disturbing a display being operated.

In the embodiments eighth to tenth, when the image data is input or received, the message screen 800 is displayed on the plurality of display devices 11 to 13 to which each specific operation is assigned for notifying the user by the message that the image data is input or received, but the present disclosure is not limited thereto. For example, in the embodiments first to seventh, when the image data is input or received, the message screen 800 may be displayed on the plurality of display devices 11 to 13 before selecting the operation target display device and the selection display device from among the plurality of display devices 11 to 13 for notifying the user by the message that the image data is input or received.

### 11. Modification Example

The present disclosure is not limited to each embodiments described above, and various modifications can be employed. That is, an embodiment obtained by combining technical means modified as necessary within the scope not departing from the gist of the present disclosure is included also in the technical scope of the present disclosure.

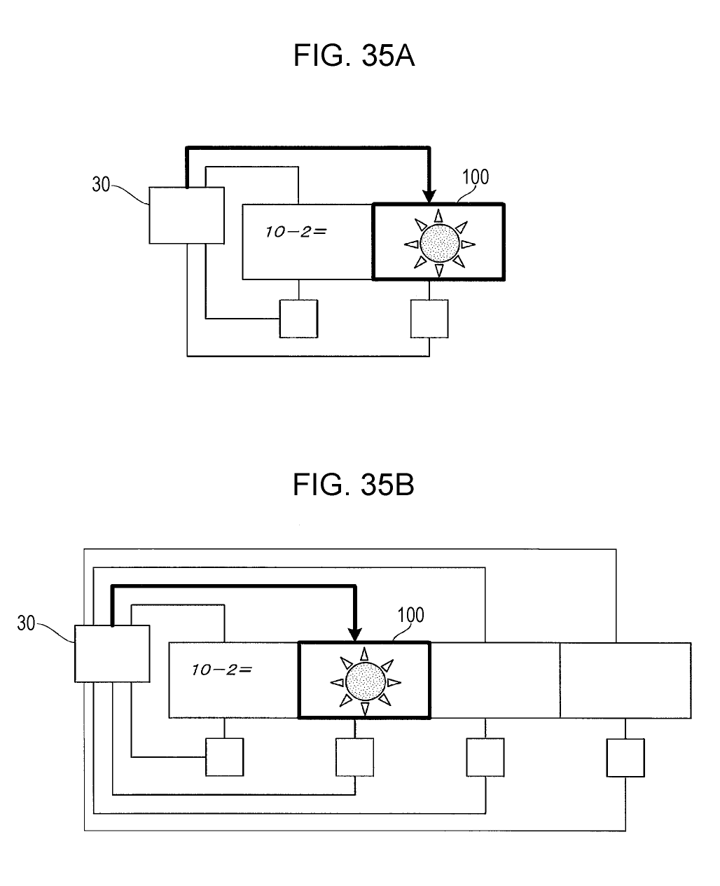

In the embodiments described above, three display devices are described as the examples, but other number of display devices may be employed. For example, two display devices may be employed as illustrated in FIG. 35A, or four display devices may be employed as illustrated in FIG. 35B. That is, it is satisfactory as long as a display device which is the operation target and another display device, as display devices, are included in the system.

It goes without saying that the embodiments described above may be combined and executed as necessary within the scope of having no contradiction in addition to examples described above.

In the embodiments, a program which is operated on each device is a program for controlling a CPU or the like (program causing a computer to function) so as to realize the functions of the embodiments described above. The information handled by the devices is accumulated temporarily in a temporary storage device (for example, RAM) at the time of processing, and then stored in a storage device of various read only memory (ROM) or a hard disc drive (HDD). The information is read by the CPU as necessary and revision or writing thereof is performed.

Here, a recording medium that stores the program may be any of a semiconductor medium (for example, ROM or non-volatile memory card), an optical recording medium and an opto-magnetic recording medium (for example, digital versatile disc (DVD), magneto optical disc (MO), mini disc (MD), compact disc (CD), or BD), or a magnetic recording medium (for example, magnetic tape or flexible disc). In addition to realization of the functions of the embodiments described above by executing a loaded program, in some cases, the functions of the present disclosure is realized by processing in cooperation with an operating system, other application programs, or the like based on an instruction of the loaded program.

In a case of distributing the program to the market, the program can be stored in a portable recording medium for the distributing or transmitted to a server computer connected through a network such as the internet. In the case, it goes without saying that the storage device of the server computer is included also in the present disclosure.

A part or all of each device in the embodiments described above can be realized typically by large scale integration (LSI) which is an integrated circuit. Each functional block of each device may be formed as a separate chip, or a part or all of each functional block may be integrated into a chip. The method of forming the integrated circuit is not limited to the LSI, may be realized by a dedicated circuit or a general purpose processor. In a case where a technology for forming the integrated circuit replacing the LSI is emerged with the development of the semiconductor technology, it goes without saying that the integrated circuit formed by the technology can be used.

The present disclosure contains subject matter related to that disclosed in Japanese Priority Patent Application JP 2016-218967 filed in the Japan Patent Office on Nov. 9, 2016, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

1. A display control device that is connected to a plurality of display devices, the display control device comprising:
a device selection unit that selects a display device operated by a user as an operation target display device from among the plurality of display devices;
a content data reception unit that receives content data; and
a display control unit that displays the received content data on a display device other than the operation target display device.

2. The display control device according to claim 1,
wherein the display control unit displays the content data in a display region of one display device among the display devices other than the operation target display device.

3. The display control device according to claim 1,
wherein the plurality of display devices are arranged side by side, and
wherein the display control unit displays the content data on a display device arranged adjacent to the operation target display device among the plurality of display devices.

4. The display control device according to claim 1, further comprising:
a determination unit that determines whether the display devices are in an operation state by a user,
wherein the device selection unit selects a display device that is determined to be in the operation state by the determination unit as the operation target display device from among the plurality of display devices.

5. The display control device according to claim 4, further comprising:
a user detection unit that detects a location of a user,
wherein the determination unit determines that a display device close to the location of the user detected by the user detection unit is in the operation state.

6. The display control device according to claim 1,
wherein the device selection unit selects a display device on which at least any of a menu, a cursor, and an active window to be operated by a user is displayed as the operation target display device from among the plurality of display devices.

7. The display control device according to claim 1,
wherein the device selection unit selects a display device on which the content data is displayed already as the operation target display device from among the plurality of display devices.

8. The display control device according to claim 1,
wherein the device selection unit selects the operation target display device from among the plurality of display devices based on a history when the user touches the plurality of display devices.

9. The display control device according to claim 8,
wherein the device selection unit selects a display device having a highest number of touches by the user as the operation target display device from among the plurality of display devices.

10. The display control device according to claim 8,
wherein the device selection unit selects a display device having a shortest elapsed time after a last touch by the user as the operation target display device from among the plurality of display devices.

11. A display control device comprising:
a content data reception unit that receives content data;
a notification control unit that notifies a user that the content data is received by displaying notification information on a plurality of display devices to each of which each specific operation is assigned;
a device selection unit that selects a display device on which the specific operation is performed by the user as the operation target display device from among the plurality of display devices; and
a display control unit that displays the received content data on a display device other than the operation target display device selected by the specific operation.

12. The display control device according to claim 11,
wherein the specific operation is at least any one of a specific gesture operation, a specific character input, or a specific flick operation.

13. A display system comprising:
a plurality of display devices; and
a display control device connected to the plurality of display devices, wherein
the display control device includes
a device selection unit that selects a display device operated by a user as an operation target display device from among the plurality of display devices;
a content data reception unit that receives content data; and
a display control unit that displays the received content data on a display device other than the operation target display device.

14-15. (canceled)
